(19) United States
(12) Patent Application Publication
(10) Pub. No.: US 2007/0190504 A1
(43) Pub. Date: Aug. 16, 2007

(54) INTEGRATED SELF-KNOWLEDGE AND CAREER MANAGEMENT PROCESS

(75) Inventors: Brian A. Schwartz, Norwalk, CT (US); Robert F. Parker, Darien, CT (US); Frank P. Bordonaro, Wilton, CT (US)

Correspondence Address: CANTOR COLBURN, LLP, 55 GRIFFIN ROAD SOUTH, BLOOMFIELD, CT, 06002, US

(73) Assignee: CAREERDNA, LLC, Darien, CT (US)

(21) Appl. No.: 11/670,037

(22) Filed: Feb. 1, 2007

Related U.S. Application Data
(60) Provisional application No. 60/763,981, filed on Feb. 1, 2006.

(51) Int. Cl. G09B 19/00

(52) U.S. Cl. 434/219

(57) ABSTRACT

A method for facilitating self-knowledge and career management including providing a user interface to a career management software tool that includes a type and temperament module, a skills and experiences module, and a career interests module. The user interface has a screen flow and includes illustrated scenarios as a form of stimuli. One or more of the modules are executed to determine characteristics of a user. The executing includes receiving information from the user via the user interface and performing user validation of the determined characteristics. The user validation includes altering the screen flow in response to the information received from the user. A job taxonomy database that includes occupational themes and associated occupational characteristics is accessed to select a subset of the occupational themes based on the determined characteristics of the user. The subset of the occupational themes is transmitted to the user via the user interface.

### CROSS-REFERENCE TO RELATED APPLICATIONS

The present application claims the benefit of provisional application No. 60/763,981 filed Feb. 1, 2006, the content of which is hereby incorporated by reference in its entirety.

### BACKGROUND

Exemplary embodiments relate generally to career management, and more particularly, to methods, systems and computer program products for integrating self-knowledge and career management.

Every year thousands of new college graduates enter the job market in the United States without knowing what kind of a career to pursue. In addition, every year thousands of employees are malting career changes (e.g., may be forced due to lay-offs or desired due to job dissatisfaction). Both types of job seekers, recent college graduates and people malting career changes, may take the first job offered without really knowing if they are suited to the type of work required by the job. This may lead to poor job performance and/or worker dissatisfaction if there is a mismatch between the personality of the worker and the characteristics required to perform the job. It would be advantageous to both the worker and the employer to avoid this mismatch. It would be desirable for job seekers to understand the types of jobs/careers that they are best suited for and to direct their job search towards these jobs/careers.

In addition, employers may have a pool of current employees that they would like to assist in directing to work positions and career paths within the corporation. Ideally, the employers would be able to match each employee with an available position in the corporation that best suits the employee's skills and interests. This would be advantageous to both the employer (e.g., less turnover) and the employee (e.g., increased job satisfaction).

Further, companies are using training, learning, development tools and programs to help employees grow and become more effective. These tools and programs often are targeted to the manager/supervisor level and rely on their ability to integrate the training/learning in order for it to have any real effect on the work performance of the frontline employees they supervise. Given this dependency, it would be advantageous in developing training programs for frontline employees to have cost-efficient and effective training tools and programs that can be self-administered by the frontline employee, using the supervisor as the overseer of an employee-driven self-development process rather than as the trainer.

As companies differentiate their goods and services from other companies, they may elect to use their employees to create a competitive advantage in their sector, for example, by offering a superior customer experience. It would be critical for such companies to discover what the critical skills are that allow their employees to do a superior job, and thus, for the company to enjoy its competitive advantage. Once these special skills are identified, they can be used as the basis for talent selection and promotion as well as for training and development programs, allowing the company to scale and sustain its competitive advantage.

More and more companies are using matrix, or team, management structures, combining multi-disciplined talents and disparate geographies, to achieve their business goals. As the effectiveness of these teams becomes critical to the company's success, it is important to develop tools to ensure that the team assembled has the necessary skills to optimize its effectiveness and that the team members and managers understand the collective skills inventory of the team and how to best use these skills in achieving the business goals.

Coaching and mentoring have become more important for individual development, both within and outside the organization. For this coaching to become scalable and more standardized, tools are needed that provide a common denominator for assessment as well as transferring more of the developmental control to the individual, allowing the coach to provide interpretive insight and mentoring help.

### BRIEF DESCRIPTION

Exemplary embodiments include a method for facilitating self-knowledge and career management. The method includes providing a user interface to a career management software tool that includes a type and temperament module, a skills and experiences module, and a career interests module. The user interface has a screen flow and includes illustrated scenarios as a form of stimuli. One or more of the modules are executed to determine characteristics of a user. The executing includes receiving information from the user via the user interface and performing user validation of the determined characteristics. The user validation includes altering the screen flow in response to the information received from the user. A job taxonomy database that includes occupational themes and associated occupational characteristics is accessed to select a subset of the occupational themes based on the determined characteristics of the user. The subset of the occupational themes is transmitted to the user via the user interface.

Other exemplary embodiments include a method for facilitating self-knowledge and career management. The method includes providing a user interface to a career management software tool that includes a type and temperament module, a skills and experiences module, and a career interests module. The user interface has a screen flow and the modules including illustrated scenarios as a form of stimuli and the modules when executing receive information from the user via the user interface and perform user validation. The user validation includes altering the screen flow in response to the information received from the user. The type and temperament module is executed to determine type and temperament characteristics of the user. A first set of records is selected from a job taxonomy database that includes occupational themes and associated occupational characteristics and job titles. The first set of records is selected based on the type and temperament characteristics of the user. The skills and experiences module is executed to determine skill characteristics of the user. A second set of records is selected from the first set of records based on the skill characteristics of the user. The career interests module is executed to determine career interests characteristics of the user. A third set of records is selected from the second set of records based on the career interest characteristics of the user. The occupational themes and the associated job titles in the third set of records is transmitted to the user via the user interface.

Other exemplary embodiments include a method for facilitating self-knowledge and career self-development. The method includes executing a type and temperament module that utilizes a screen flow and illustrated scenarios to determine type and temperament characteristics of a user. The executing of the type and temperament module includes communicating the determined characteristics to the user and user validation of the determined characteristics. The user validation includes altering the screen flow in response to the information received from the user. A skills and experiences module is executed to determine current skills of the user. The current skills include one or more of physical skills, social skills, information skills, and ideas skills. A list of critical skills required for a job position is accessed. The current skills of the user are compared to the critical skills. A development plan for the user is then created based on the results of the comparing.

Further exemplary embodiments include a computer program product for facilitating self-knowledge and career management. The computer program product includes a storage medium readable by a processing circuit and storing instructions for execution by the processing circuit for performing a method. The method includes providing a user interface to a career management software tool that includes a type and temperament module, a skills and experiences module, and a career interests module. The user interface has a screen flow and includes illustrated scenarios as a form of stimuli. One or more of the modules are executed to determine characteristics of a user. The executing includes receiving information from the user via the user interface and performing user validation of the determined characteristics. The user validation includes altering the screen flow in response to the information received from the user. A job taxonomy database that includes occupational themes and associated occupational characteristics is accessed to select a subset of the occupational themes based on the determined characteristics of the user. The subset of the occupational themes is transmitted to the user via the user interface.

Further exemplary embodiments include a system for facilitating self-knowledge and career management. The system includes a job taxonomy database and a processor. The job taxonomy database includes occupational themes and associated occupational characteristics. The processor is in communication with the job taxonomy database and with a user system, which includes instructions to facilitate a method. The method includes providing a user interface to a career management software tool to a user at the user system. The career management software tool includes a type and temperament module, a skills and experiences module, and a career interests module. The user interface has a screen flow and includes illustrated scenarios as a form of stimuli. One or more of the modules are executed to determine characteristics of a user. The executing includes receiving information from the user via the user interface and performing user validation of the determined characteristics. The user validation includes altering the screen flow in response to the information received from the user. The job taxonomy database is accessed to select a subset of the occupational themes based on the determined characteristics of the user. The subset of the occupational themes is transmitted to the user via the user interface.

Still further exemplary embodiments include a method for determining critical skills for a job position. The method includes having one or more users execute a skills and experiences module. The one or more users have a selected job position. The skills and experiences module is executed to determine current skills of each of the users, with each current skill categorized as one or more of a physical skill, a social skill, an information skill, and an ideas skill. The executing includes facilitating an evaluation by each of the users of the importance of each of the current skills to the job position. A list of critical skills for the selected job position is created based on the current skills and the evaluations of the users.

Still further exemplary embodiments include a method for determining critical skills for a team. The method includes having one or more users associated with a team executing a type and temperament module, and a skills and experiences module. The type and temperament module utilizes illustrated scenarios to determine type and temperament characteristics of the user. The executing includes communicating the determined characteristics to the user and user validation of the determined characteristics. The user validation includes altering the screen flow in response to information provided by the user. The skills and experiences module is executed to determine current skills of the user, with each current skill categorized as one or more of a physical skill, a social skill, an information skill, and an ideas skill. A list of critical skills required for the team is accessed. The current skills of the users are compared to the critical skills required for the team to identify gaps between the current skills of the user and the critical skills required for the team.

### BRIEF DESCRIPTION OF THE DRAWINGS

Referring now to the drawings wherein like elements are numbered alike in the several FIGURES:

FIG. 1 depicts an overall process flow that may be implemented by exemplary embodiments of the software to guide a user through an integrated self-knowledge and career management process;

FIG. 2 is an exemplary introductory user interface screen for the self-knowledge and career management process;

FIG. 3 is an exemplary introductory user interface screen for the type and temperament game;

FIG. 4 is an exemplary initial user interface screen for providing the user with information about progress through the career management software;

FIG. 5 is an exemplary user interface screen with an illustrated scenario for determining a direction of mental energy characteristic of the user in the type and temperament game;

FIG. 6 is an exemplary user interface screen with an illustrated scenario for determining a direction of mental energy characteristic of the user in the type and temperament game;

FIG. 7 is an exemplary user interface screen with a summary of a direction of mental energy characteristic of the user in the type and temperament game;

FIG. 8 is an exemplary tie breaker user interface screen for the type and temperament game;

FIG. 9 is an exemplary user interface screen with a personality type of the user based on the characteristics determined in the type and temperament game;

FIG. 10 is an exemplary user interface screen for exiting the type and temperament game;

FIG. 11 is an exemplary user interface screen for displaying the results of the type and temperament game to the user;

FIG. 12 is an exemplary user interface screen for displaying the results of the type and temperament game to the user;

FIG. 13 is an exemplary user interface screen for providing the user with information about progress through the career management software;

FIG. 14 is an exemplary user interface screen for providing the user with information about progress through the career management software;

FIG. 15 is an exemplary user interface screen for the skills and experiences game;

FIG. 16 is an exemplary user interface screen for the skills and experiences game;

FIG. 17 is an exemplary user interface screen for the skills and experiences game;

FIG. 18 is an exemplary user interface screen for the skills and experiences game;

FIG. 19 is an exemplary user interface screen for the skills and experiences game;

FIG. 20 is an exemplary user interface screen for providing the user with information about progress through the career management software;

FIG. 21 is an exemplary user interface screen for performing the defining occupational interests portion of the career interests and card sort game;

FIG. 22 is an exemplary user interface screen for performing the values toggle portion of the interests and values game;

FIG. 23 is an exemplary user interface screen for providing the user with information about progress through the career management software;

FIG. 24 is a block diagram of an exemplary system for providing an integrated self-knowledge and career management process;

FIG. 25 depicts contents of an exemplary job taxonomy database that may be utilized by the career management software;

FIG. 26 depicts an exemplary user interface screen for providing employee access to career management software tailored to a specific corporation;

FIG. 27 depicts an exemplary user interface for listing the top skills of an employee;

FIG. 28 depicts an exemplary user interface for comparing the skills of an employee to critical skills for a job position;

FIG. 29 depicts an exemplary user interface for analyzing employee skills to critical skills required for a position held by the employee;

FIG. 30 depicts an exemplary user interface screen for creating an employee development plan;

FIG. 31 is a block diagram of a process that may be implemented by exemplary embodiments to facilitate self-knowledge and career management;

FIG. 32 is a block diagram of a process that may be implemented by exemplary embodiments to facilitate career coaching;

FIG. 33 is a block diagram of a process that may be implemented by exemplary embodiments to facilitate determining critical skills for a job position; and

FIG. 34 is a block diagram of a process that may be implemented by exemplary embodiments to facilitate determining critical skills for a team.

### DETAILED DESCRIPTION

Exemplary embodiments include an online, highly interactive, user-driven solution to integrate self-knowledge and career management. Exemplary embodiments are implemented in software (referred to herein as “the career management software” or as “the career management software tool”). The career management software is designed to maximize human potential and to change how knowledge workers manage their careers. The career management software takes the user through a journey of self-discovery providing an understanding of personality type, temperament, transferable skills, values, and interests. The results of the self-discovery process are mapped to a career path, including determining possible occupations from a database, or job taxonomy database, of occupations, that appear to be a good fit for the personality type, temperament, skills, values and interests of the user.

The career management software permits each user to self-validate outcomes at each stage. These self-discovery outputs are highly actionable and the user can explore specific job profiles with detailed descriptions that are served-up from an extensive job taxonomy database. Additionally, users can build a “passion-based” resume, script a succinct statement of career objectives and prepare for in-person interviews, all with individualized content harvested from the self-discovery process.

Exemplary embodiments are directed toward the beginning and early career user such as, but not limited to, students, entry-level, and young transitional employees. Users build a highly effective career plan from the inside out using the career management software. In the “validation” phase of the process, they assess their “hard wiring” (i.e., type, temperament, skills, values and interests) and map these results to specific occupations in their indicated careers. In essence, they validate their own workforce assets and desires, and then access a job taxonomy database to discover their best career options. Users can then assess those career options to achieve certainty and ownership of a career path that fits them. After the “validation” phase, users seamlessly, and effortlessly, transition into the “self-marketing” phase, which is driven by the assessment part of the process. Here, they receive a type and temperament profile, a transferable skills profile, and an interests and values summary. At the “journey's” conclusion, they use these outputs to populate their personalized marketing tools (e.g., a resume, and an “elevator pitch”) and prepare forceful, confident answers to the five most frequently asked questions in job interviews.

Exemplary embodiments of the career management software tool include a coaching functionality to initiate a long-term relationship with the user, such as how to deal with the five key issues the user is likely to encounter in his new job. Exemplary embodiments also include digital coaching functionality such as e-mails, organizational games, and a variety of e-learning tools to help users optimize their talent and career potential on a continual and on-going basis. Exemplary embodiments further include building a community of users through memberships that facilitate the exchange of referrals and other networking information valuable to the members/users.

Alternate exemplary embodiments of the career management software, as described herein below, are directed to use by employees of a corporation to develop career plans and development actions based on an employee's current skills and the skills required by particular job positions within the corporation. In these embodiments, the job taxonomy database includes job positions that are available within the corporation (all positions or only those with a current opening) and the critical skills required for the job positions. The critical skills may be determined by assessing the skills utilized and deemed important by employees who are (or were) high performers when holding the job position. Alternatively, the critical skills may be determined by supervisors of employees who hold the job position.

Additional alternate embodiments, as described herein below, are directed to determining critical skills for a team. In these embodiments, the job taxonomy database includes critical skills required by the team. These critical skills may be determined by the team leader and/or by analyzing the critical skills possessed by previous successful teams. The skills of each member of the team are assessed and their collective skills are compared to the critical skills required by the team. The gap between critical skills required by the team and the collective skills may then be met by changing the make-up of the team and/or by developing current team member(s).

Exemplary embodiments of the career management software include computer adaptation to input flow; user-directed inputs; self-validation; and an engaging, interactive, visual experience for the user. In addition, in exemplary embodiments, ownership of the results belongs to the individual (user) being assessed and not to a third party. The career management software is accessed by an individual via a user device connected to a network. The user works through the self-knowledge and career management process at his or her own pace and may take one or more sessions to complete the process.

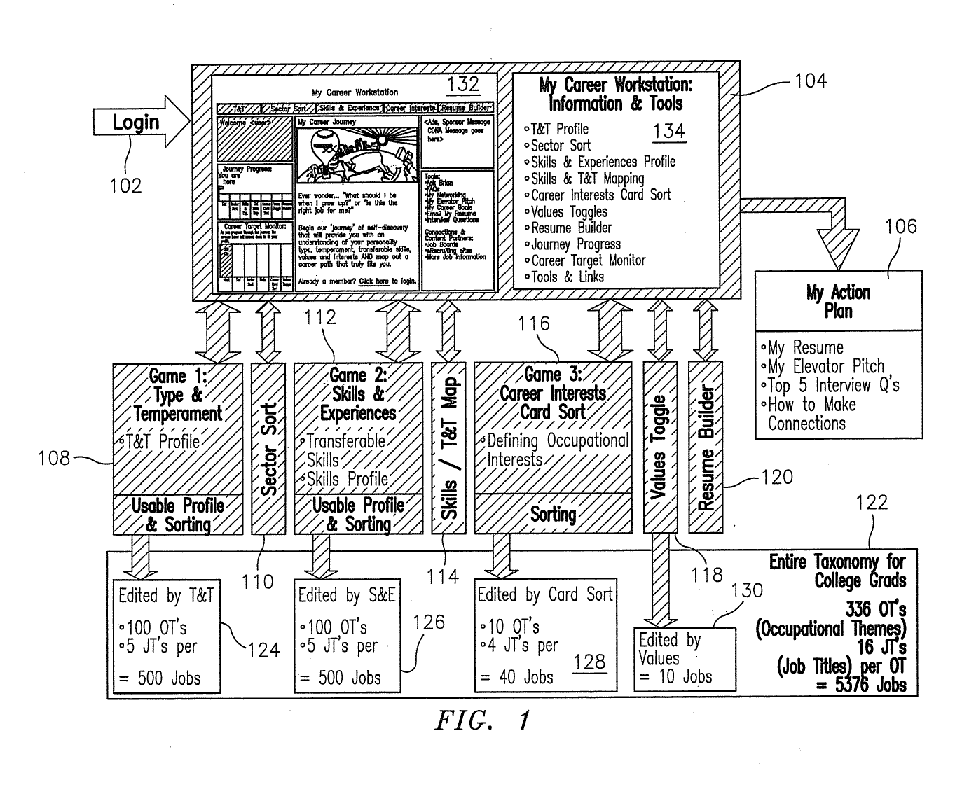

FIG. 1 depicts an overall process flow that may be implemented by exemplary embodiments of the career management software tool to guide a user through an integrated self-knowledge and career management process. In exemplary embodiments, a module referred to as “my career workstation” 104 (includes both the user interface 132 and a user output file interface 134) is utilized to step the user through the integrated self-knowledge and career management process. In exemplary embodiments, the user output file interface 134 provides the user with a manner of accessing results files created by the career management software (e.g., a type and temperament profile and a skills and experiences profile). In other exemplary embodiments, the user output file interface 134 is a subset of the user interface 132. At each step, the user can determine which portions of the process have been completed, the results of completed portions (accessible via the user output file interface 134) and which activities have not been completed. In addition, the user interface 132 includes access to tools including, but not limited to: ask Brian (e.g., ask an expert); frequently asked questions, my networking (e.g., status/plans); my elevator pitch; my career goals; email my resume; and interview questions. In addition, advertisements and sponsor messages may appear on the interface screen. Further, the interface screen may include access to job boards, recruiting sites and job information. The user interface 132 may be adapted based on user requirements.

The process of integrated self-knowledge and career management begins at the login block 102 when the user logs on to the career management software via the workstation module 104. In exemplary embodiments, such as the one depicted in FIG. 1, the career management software is customized for users who are about to graduate from college or who are recent college graduates. A job taxonomy database 122 for college graduates is accessed by the career management software to provide information about occupational themes (OTs) and the job titles (JTs) associated with each OT/JT combination that applies to college graduates.

In exemplary embodiments, the taxonomy is stored in a database (or other storage mechanism) that is accessed by the career management software. The job taxonomy database 122 includes the OTs and JTs along with characteristics and descriptive profiles associated with the OTs and JTs. These characteristics may include, but are not limited to: sector, salary, skills, and personality. A custom job taxonomy database 122 may be designed for the career management software. Alternatively, an existing database such as, but not limited to, the Occupational Network (ONET) database maintained by the United States Government may be utilized by the career management software. In addition, an existing database (e.g., ONET) may be utilized and customized for use by the career management software. Alternate embodiments are customized for any group of job seekers such as, but not limited to, high school graduates, law school graduates, employees of a particular corporation, and people making career changes.

In the exemplary embodiment depicted in FIG. 1, the entire job taxonomy database 122 for college graduates contains over three hundred occupational themes (OTs) with each OT including several job titles (JTs), resulting in over five thousand jobs. When the user first starts the career management process, all of these OTs and JTs are considered possible fits for the user. As the career management process continues through the various games, the user ends up with a small subset of these JTs as suggested career fits for the user. This winnowing down to a subset is performed by matching information provided by the user during the self-knowledge and career management process with characteristics associated with the OTs/JTs. In exemplary embodiments, the job taxonomy database 122 includes characteristic information for OTs/JTs that includes, but is not limited to: sector, salary, skills, and personality traits. In the exemplary embodiment depicted in FIG. 1, the number of JTs is ten when the user has completed the career management process.

FIG. 1 is intended to be exemplary in nature and other numbers of OTs and JTs at the start, middle and end of the career management process may result. The number of OTs and JTs suggested along the management process may depend on several factors such as, but not limited to, the data in the job taxonomy database 122 and the results of the games. In addition, the career management software may be tailored to produce a targeted number of OTs and JTs for each step in the process.

Game 1 in FIG. 1 is a type and temperament game (implemented by a type and temperament module 108 in the career management software) that results in a type and temperament profile (accessible by the user via the user output file interface 134) based on input received from the user. The type and temperament profile is used to narrow down the number of OTs and JTs that may be suggested to the user. The narrowing down may be implemented by matching type and temperament characteristics of the user with type and temperament characteristics associated with the OTs and JTs in the job taxonomy database 122. In exemplary embodiments, the job taxonomy database 122 includes type and temperament characteristics associated with the OTs and/or JTs. The OTs and JTs that have characteristics that match and/or that are closest and/or meet some other match criteria when compared to the type and temperament characteristics in the user's type and temperament profile remain on the list for the user. A similar narrowing down of potential OTs and JTs for the user occurs as each game is played. In an alternate exemplary embodiment, type and temperament characteristics are associated only with the OTs, and JTs within an OT are assumed to have the same type and temperament characteristics as the OT.

Game 2 in FIG. 1 is a skills and experiences game (implemented by a skills and experiences module 112 in the career management software), and Game 3 is a career interests card sort game (implemented by a career interests module 116 in the career management software). Similar to the type and temperament game, the career interests card sort game further narrows down the number of potential OTs and JTs that may be suggested to the user (in the example depicted in FIG. 1 down to forty jobs). Also depicted in FIG. 1 is a sector sort module 110 (part of the career management software) that may be performed by the user to determine the types of industries that the user prefers. FIG. 1 also depicts a skills/type and temperament map module 114 implemented by the career management software that allows the user to view the results of both the skills, and type and temperament exercises side by side. This is one example of cross-pollination, where the outputs from individual modules are co-presented so that the user can identify themes and patterns. As depicted in FIG. 1, the values toggle module 118 in the career management software further narrows down the number of suggested OTs and JTs for the user (in the example depicted in FIG. 1 down to ten jobs). The elements depicted in FIG. 1 are further described herein below.

At the end of the process depicted in FIG. 1, the user has a relatively small list of potential job titles that reflect the input provided by the user. In exemplary embodiments, the next step is to create an action plan that may include activities such as creating a resume (via the resume builder module 120), creating an “elevator pitch” (a quick way to communicate who the user is), preparing responses to likely interview questions (as suggested by the career management software), and learning how to make connections in the remaining JTs (based on suggestions by the career management software). In this manner, the workstation module 104, along with output from the self-knowledge and career management process, may be utilized by the user to assist in finding a job, to create a self-presentation and/or to make career decisions. In exemplary embodiments, this is performed via an action plan module 106, which may include, but is not limited to software for facilitating: creating a resume, creating an elevator pitch, preparing responses to the top five interview questions and learning about how to make connections.

In exemplary embodiments, suggested responses to likely interview questions and suggestions on how to make connections are different based on the results of one or more of the games played by the user (e.g., the type and temperament game, and the skills and experiences game). Further, in exemplary embodiments, one or more of the user interface screens are modified (e.g., the delivery medium is modified from text to graphics and/or the content of the messages are modified) based on the results of the one or more games played by the user. For example, a user that appears to have characteristics that suggest that the user responds better to illustrations may be presented with more graphics on the user interface screens, while a user that appears to have characteristics that suggest that the user responds better to text may be presented with more text (than graphics) on the user interface screens. These modifications may occur during the games and/or after a profile including characteristics of the user is created.

In alternate exemplary embodiments, the games are performed in a different order and/or different games are played. For example, in an exemplary embodiment, only the type and temperament game, and the skills and experiences game are played by the user (which will typically result in more jobs in the final list). The actual games and order may be tailored based on user requirements. In exemplary embodiments, the user may play each game more than once and/or make changes to the results of the games as part of the career management process.

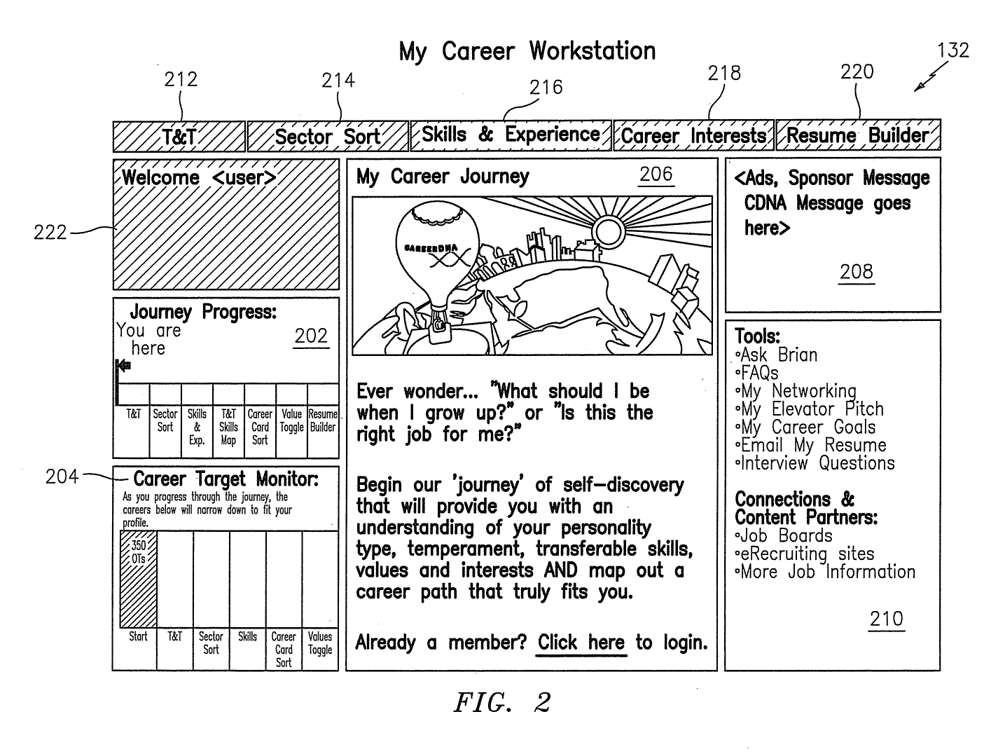

FIG. 2 is an exemplary introductory user interface screen 132 for the career management software. It is intended to be an introduction to the self-knowledge and career management process and to let the user know what to expect. The user interface screen 132 includes: a user message area 222 for posting personalized information to the user such as the user name; a journey progress chart 202 depicting the users place in the process implemented by the career management software; a career target monitor 204 for displaying the number of potential jobs for the user; an advertising space 208 for displaying paid advertisements or other messages; and a tools box 210 for accessing related information. The user interface screen 132 depicted in FIG. 2 also includes a type and temperament tool bar 212 for initiating the type and temperament module 108; a sector sort tool bar 214 for initiating the sector sort module 110; a skills and experiences tool bar 216 for initiating the skills and experiences module 112; a career interests tool bar 218 for initiating the career interests module 116; and a resume builder tool bar 220 for initiating the resume builder module 120. The user interface screen 132 depicted in FIG. 2 also includes a content panel 206 to display information and instructions to the user.

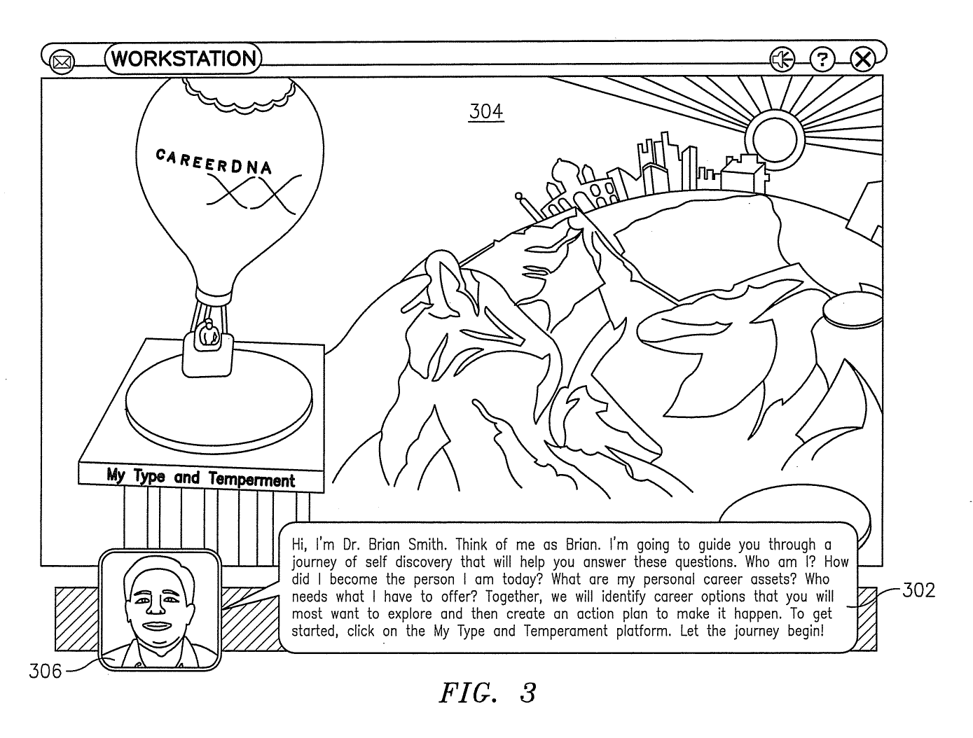

FIG. 3 is an exemplary introductory user interface screen for the type and temperament game. The user interface screen depicted in FIG. 3 includes a content panel 304, a picture of a “coach” 306 who is guiding the user through the process and a text message or prompt 302 from the coach 306. In alternate embodiments, the coach is depicted on the user interface via a video clip and speaks the words in the prompt 302.

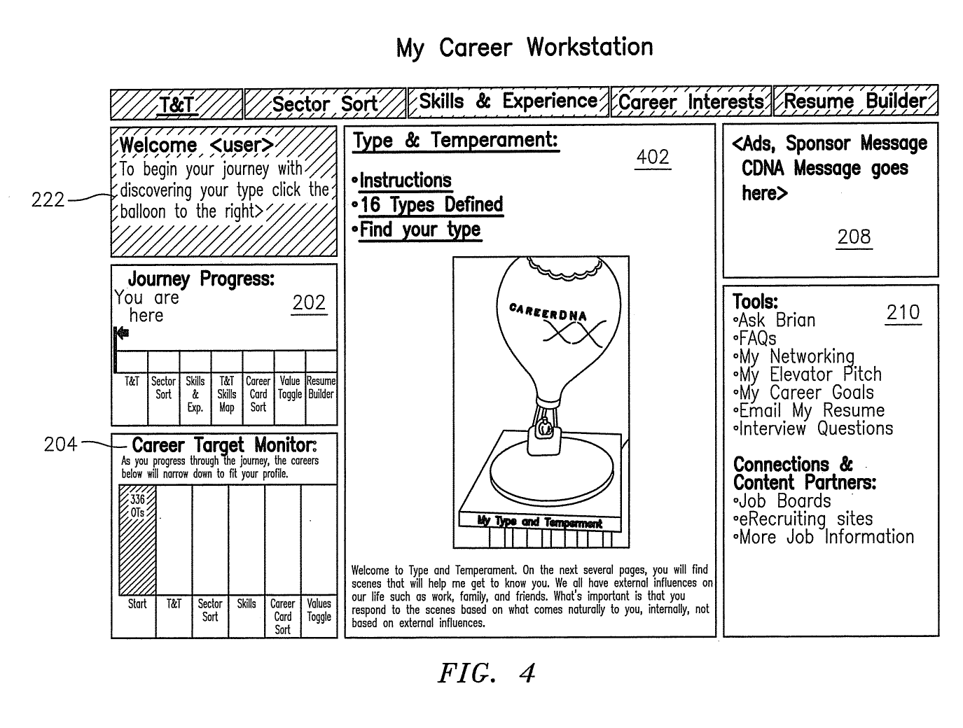

FIG. 4 is an exemplary initial user interface screen for providing the user with information about progress through the career management software and for instructing the user about accessing the type and temperament game. The user message area 222 displays the text “Welcome <user name>. To begin your journey discovering your type, click the balloon to the right.” The journey progress chart 202 shows that the user is at the start of the process and the career target monitor 204 shows that there are 336 possible occupational themes that will be considered for the user. The content panel 402 gives further information to the user about the type and temperament game. When the user clicks on the balloon, as instructed by the message area 222, the type and temperament module 108 is initiated to allow the user to play the type and temperament game. Software code in the type and temperament module 108 causes the user interface 132 to present particular type and temperament screens, to record the user responses, and to select occupational themes and job titles within the job taxonomy database 122 that fit the user type and temperament characteristics as determined by the user responses (also referred to herein as information received from the user).

In exemplary embodiments, the user is forced to go through the process in the order specified by the workstation module 104, while in other exemplary embodiments, the user may perform the career management process in any order. In addition, the user may access tools listed in the tools box 210 and connect to other web sites and/or software applications via the user interface 132. More introduction screens with further information and/or user instructions may be presented to the user via the user interface 132 before the type and temperament game is started.

In the embodiments described herein, the type and temperament of the user is expressed in terms of the sixteen types popularized by Meyers Briggs and David Keirsey. The sixteen types are typically abbreviated as four letters (e.g., “ENJF”) that reflect an information gathering characteristic, a mental energy characteristic, an executing characteristic, and a deciding characteristic.

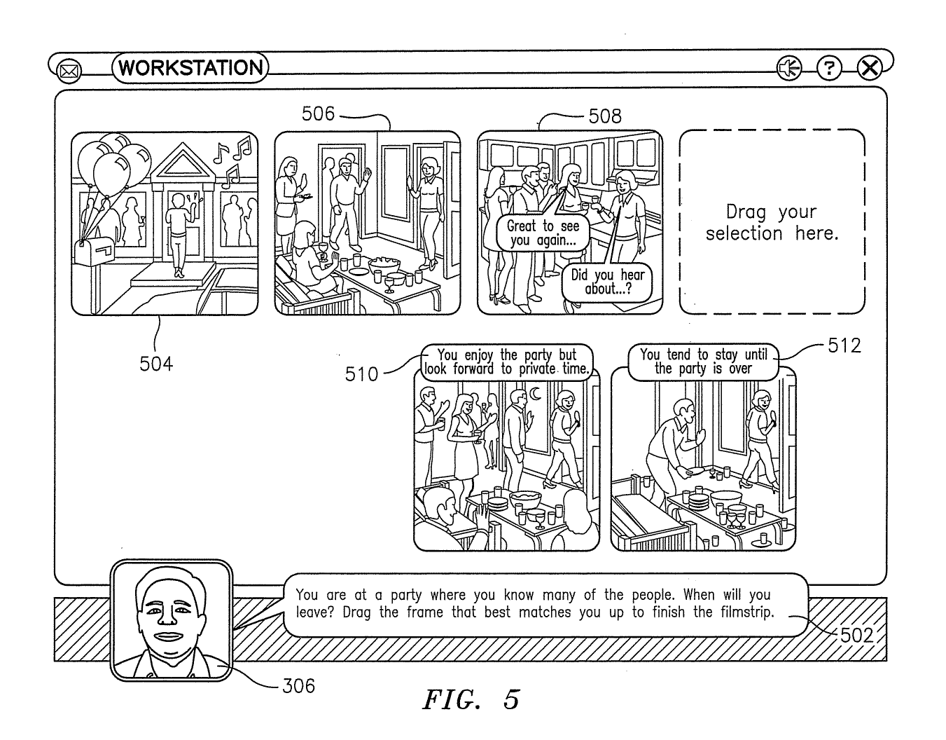

FIG. 5 is an exemplary user interface screen with an illustrated scenario for determining a direction of mental energy characteristic of the user in the type and temperament game. FIG. 5 depicts an illustrated scenario using three frames 504 506 508, and the prompt 502 instructs the user to select a frame that best reflects the action that the user would take. The selection is performed by dragging either frame 510 or frame 512 to complete the filmstrip. The user interface 132 depicted in FIG. 5 is intended to be exemplary in nature and other user interfaces (e.g., text and voice) may be implemented by exemplary embodiments. Further, more than two options to select between may be presented to the user.

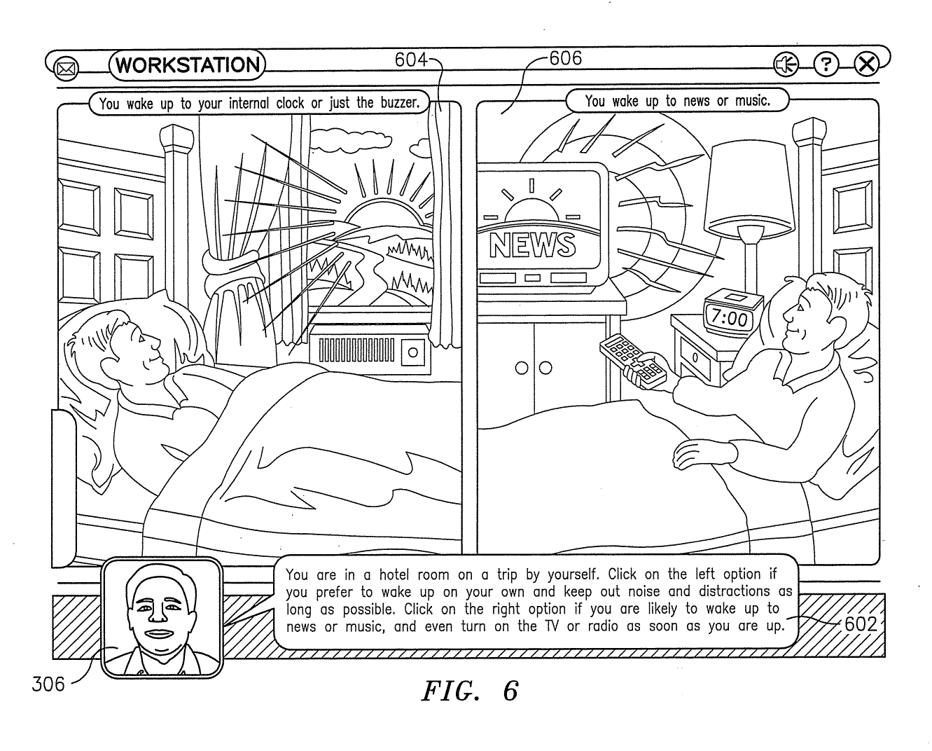

FIG. 6 is another type of user interface screen with an illustrated scenario that may be presented to the user via the user interface 132 for determining a direction of mental energy characteristic of the user in the type and temperament game. In the screen depicted in FIG. 6, the user is prompted to select which of the two options best describe what they would do in the situation. The number of scenarios presented to the user via the user interface 132 and the content of the scenarios used to determine a direction of mental energy may vary between implementations and/or users and may be modified based on experience and/or new information. In general, the career management software will cause enough scenarios to the user to be able to make an assessment of the direction of mental energy characteristic of the user.

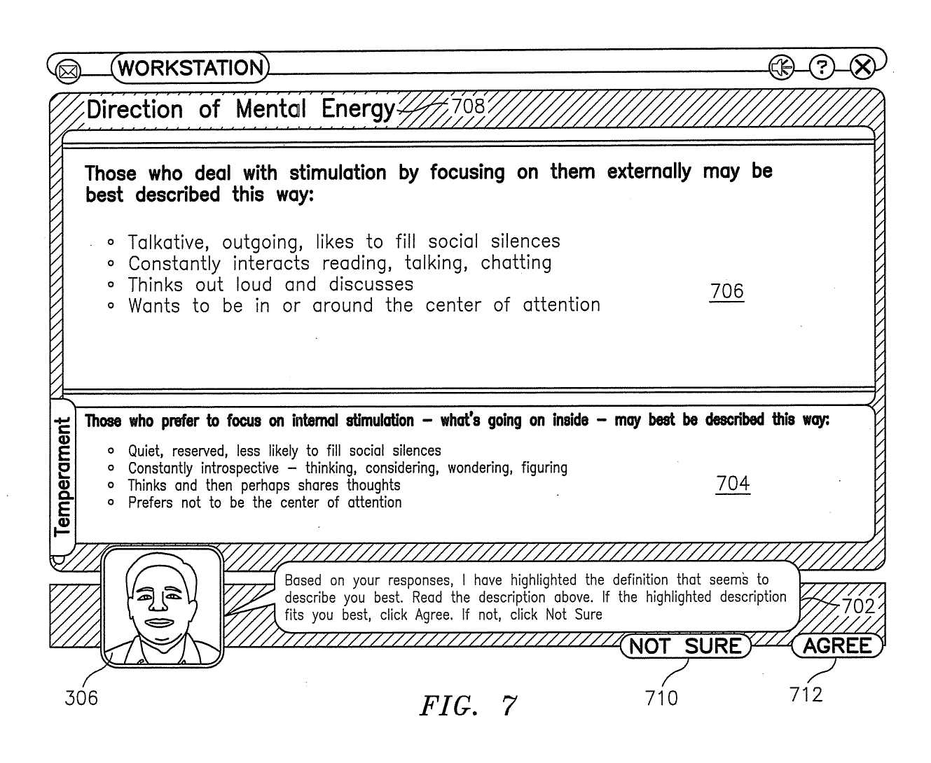

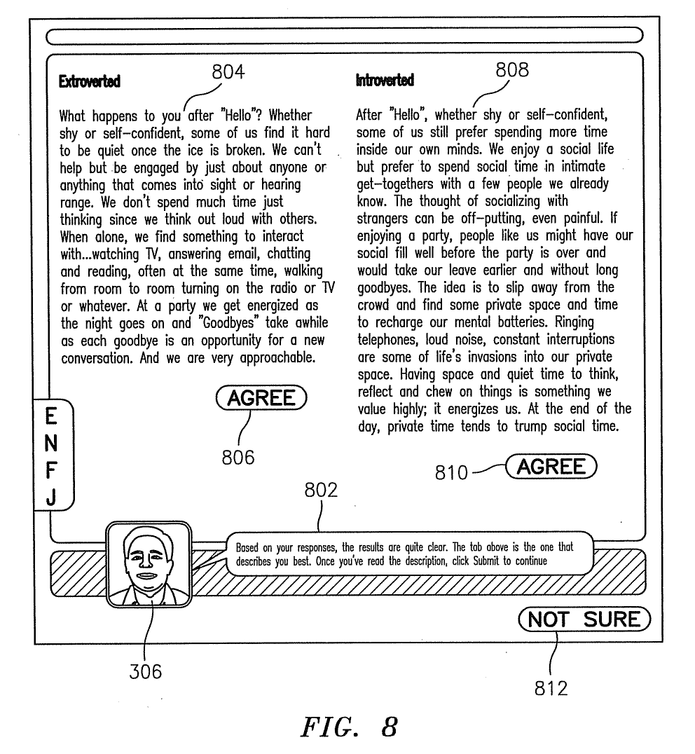

FIG. 7 is an exemplary user interface screen with a summary of a direction of mental energy characteristic 708 of the user based on information collected in the type and temperament game. The user is given a prompt 702 by the coach 306 about how to respond to the screen. The text in FIG. 7 describes attributes 706 associated with the mental energy characteristic that the career management software has assigned to the user (extrovert in this case) based on the way that the user has responded in the type and temperament game. The text also describes the attributes 704 associated with the mental energy that has not been assigned to the user (introvert in this case). The user reads through the text and then selects “agree” 712 if he thinks that that assessment is accurate and “not sure” 710 if he does not think that the assessment is accurate or is not sure if the assessment is accurate. In exemplary embodiments, if not sure is selected, then one or more tie-breaker user interface screens, such as the one depicted in FIG. 8 is presented to the user. In alternate exemplary embodiments, if not sure is selected, the type and temperament game continues with more scenarios and/or more text. This process continues until the user agrees that the assessment is connect. This allows for self-validation by the user of the assessment. Once the user agrees that the assessment of this characteristic is accurate, it is placed in the type and temperament profile for the user.

In exemplary embodiments, the type and temperament module 108 performs similar processing to assess an information gathering characteristic (e.g., intuitive or sensing), a deciding characteristic (e.g., thinking or feeling) and an executing characteristic (e.g., judging or perceiving) of the user.

For example, to determine an information gathering characteristic, the user could be presented with an illustrated scenario asking the user what he typically remembers about a person that he has just met (e.g., remembers an overall impression or remembers specific details). In addition, or instead, the user could be presented with an illustrated scenario asking the user whether he would typically refer to an instruction manual before assembling a new bicycle or whether he would begin assembly and only access the instruction manual if he gets stuck. A further scenario could be presented that determines if the user is more interested in the details (e.g., the trees) or the entire scene (e.g., the forest) when exploring a new place or subject. The user responses to the scenario prompts are then utilized to determine if the user is someone who is likely to use their sixth sense, or intuition when taking in information, or is more likely to use their five senses when talking in information. Once the likely information gathering characteristic is determined by the type and temperament module 108, user validation is performed by presenting a description associated with the characteristic and asking the user if he is in agreement with the assessment. In exemplary embodiments, a user is intuitive if a sixth sense or intuition is used when talking in information and the user can be described as: likes ideas, theories, concepts, more experimental and innovative; learns best by seeing the underlying patterns and principles; focuses on the future and possibilities; looks at the overview—big picture; likes to learn new skills and then move on to new challenges; and likes what's new, cutting-edge, unusual. A user's information gathering style may be described as sensing if the user relies his five senses when taking in information and the user can be described as: likes facts, practical, more concrete and literal; learns best by seeing examples of ideas, theories, concepts; focuses on what is happening in the present; looks at details; likes to use skills already learned and then do them better; and likes what's familiar, secure, certain.

To determine a deciding characteristic, the user could be presented with an illustrated scenario asking the user whether he typically buys a car based on the design and the way the car makes him feel, or based on the car having the specifications that he requires. In addition, or instead, the user could be presented with an illustrated scenario asking the user whether he would typically try to fix a personal problem upsetting a friend, or instead listen to the problem and show empathy for the friend. The user responses to the scenario prompts are then utilized to determine if the user is someone who is likely to make decisions using their feelings or to make decision by thinking through them. Once the likely deciding characteristic is determined by the type and temperament module 108, user validation is performed by presenting a description associated with the characteristic and asking the user if he is in agreement with the assessment. In exemplary embodiments, a user who prefers making decisions using his feelings can be described as: values the impact of decisions on other people, less dependent on logic; emotionally involved, empathetic, personal, subjective; supportive and encouraging, more likely to accept things based on emotions; and more tactful than truthful, diplomatic. A user who prefers making decisions by thinking them through can be described as: logical, objective, analytical; critical, even skeptical, yet fair; more truthful than tactful; and impersonal, detached in decision-making.

To determine an executing characteristic, the user could be presented with an illustrated scenario asking the user how much he plans in advance for a trip, and/or an illustrated scenario asking the user about whether he plans out his weekends or leaves his options open. The user responses to the scenario prompts are then utilized to determine if the user is someone who is likely to apply their judgments in a disciplined, plan-oriented way or who is likely to value the process involved in making choices. Once the likely executing characteristic is determined by the type and temperament module 108, user validation is performed by presenting a description associated with the characteristic and asking the user if he is in agreement with the assessment. In exemplary embodiments, a user who prefers applying judgments in a disciplined, plan-oriented say can be described as: likes to close and finish things, get them decided; places more value on completing work and then playing; prefers structure and creates it when needed; plans ahead, has to-do lists either written or in their heads; works steadily and regularly towards achieving goals; and organized, good with deadlines, internalizes them. A user who values the process involved in making choices may be described as: likes to keep options open for as long as possible; wants both work and play to be more like play; plans tend to be vague, prefers operating “by seat of their pants”; works spontaneously and casually; deadlines are external and are signals that perhaps work should start; and less emphasis on organization, generally rushes and is often late.

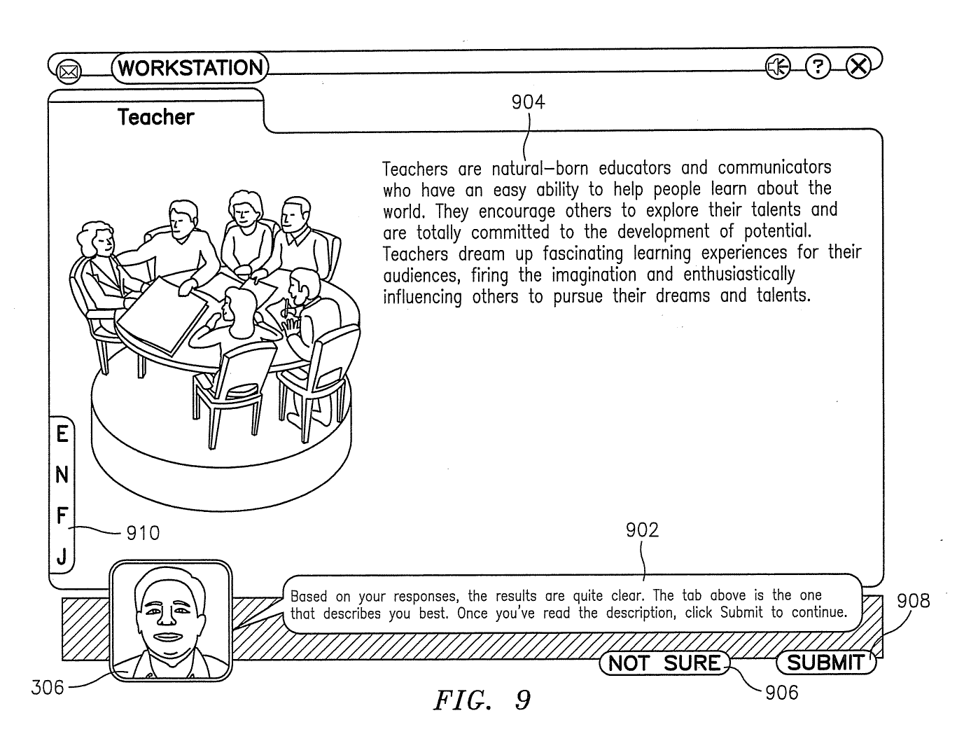

FIG. 9 is an exemplary user interface screen describing a personality type of the user based on the characteristics determined in the type and temperament game. In the example depicted in FIG. 9, the user has characteristics that include extroverted, intuitive, feeling and judging as depicted by the “ENFJ” in block 910 on FIG. 9. In exemplary embodiments, this means that that the user is categorized as a teacher and the attributes of a teacher 904 are described. Again, this is self-validating and the user and selects “submit” 908 to indicate agreement or “not sure” 906 as prompted 902 by the coach 306. If the user selects “not sure”, then a tie-breaker screen is presented to the user, and/or the type and temperament game continues with more illustrated scenarios and/or more text. This process continues until the user agrees that the overall personality assessment is correct. This allows for self-validation by the user of the assessment. Once the user agrees that the assessment is accurate, the user type and temperament characteristics are stored in the type and temperament profile for the user.

The personality descriptions for each combination of type and temperament characteristics are stored on a storage device that is accessible by the career management software. These personality descriptions may be modified and vary between implementations based on expected users of the software (e.g., recent college graduates, mid-career, etc.).

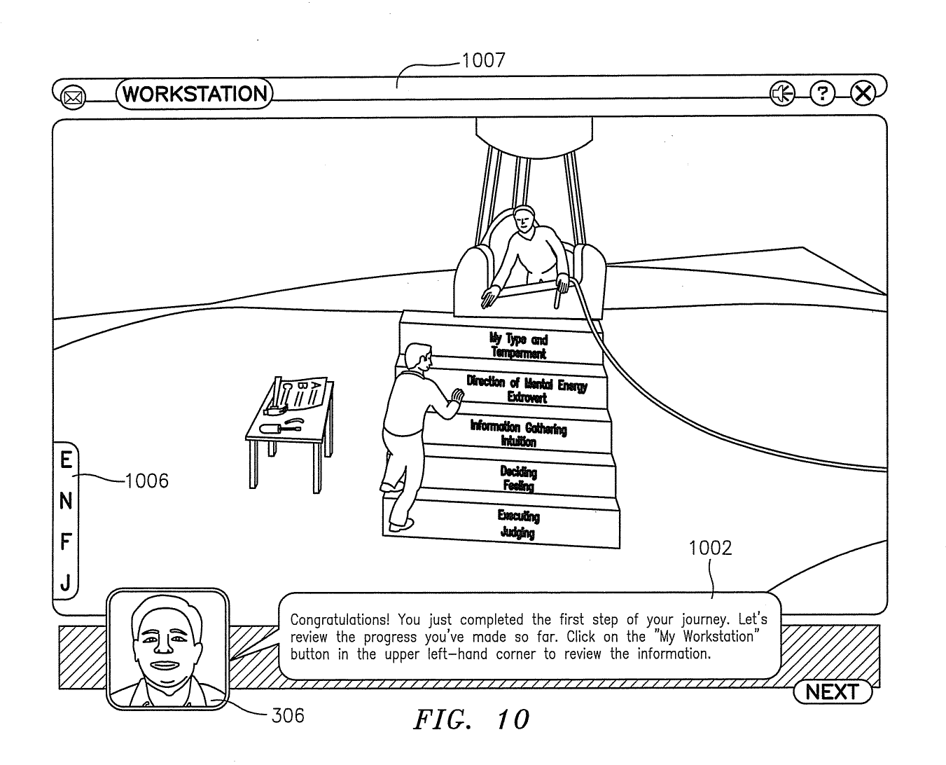

FIG. 10 is an exemplary user interface screen for exiting the type and temperament game, and thus, the type and temperament module 108. FIG. 10 is typically displayed after the type and temperament profile has been completed as described above. The user interface screen includes a content panel 1004 describing the user characteristics along with block 1006 displaying the first letters of the characteristics. In addition, the user interface screen contains a prompt 1002 from the coach 306.

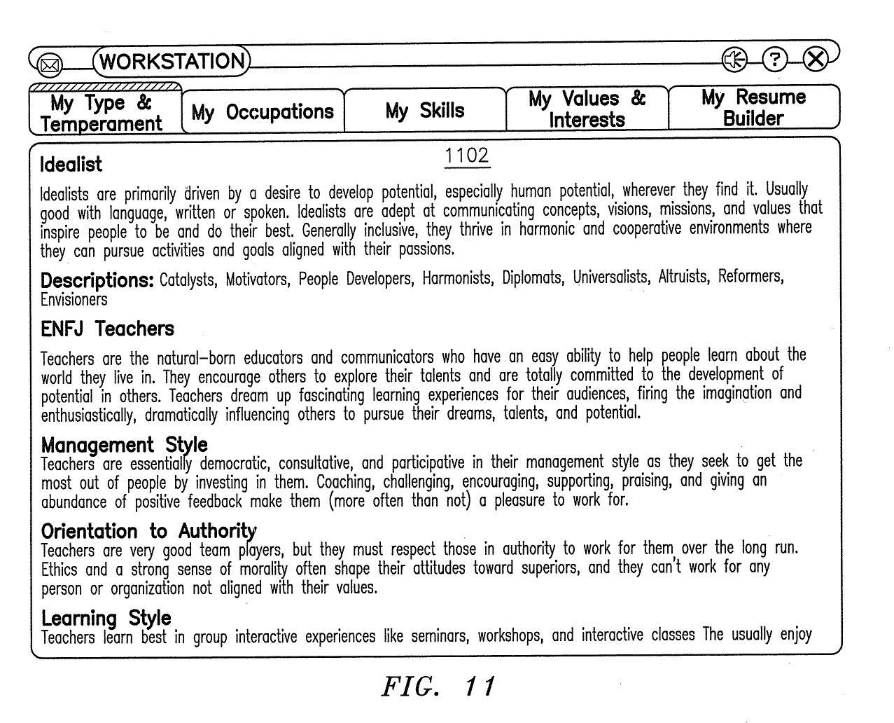

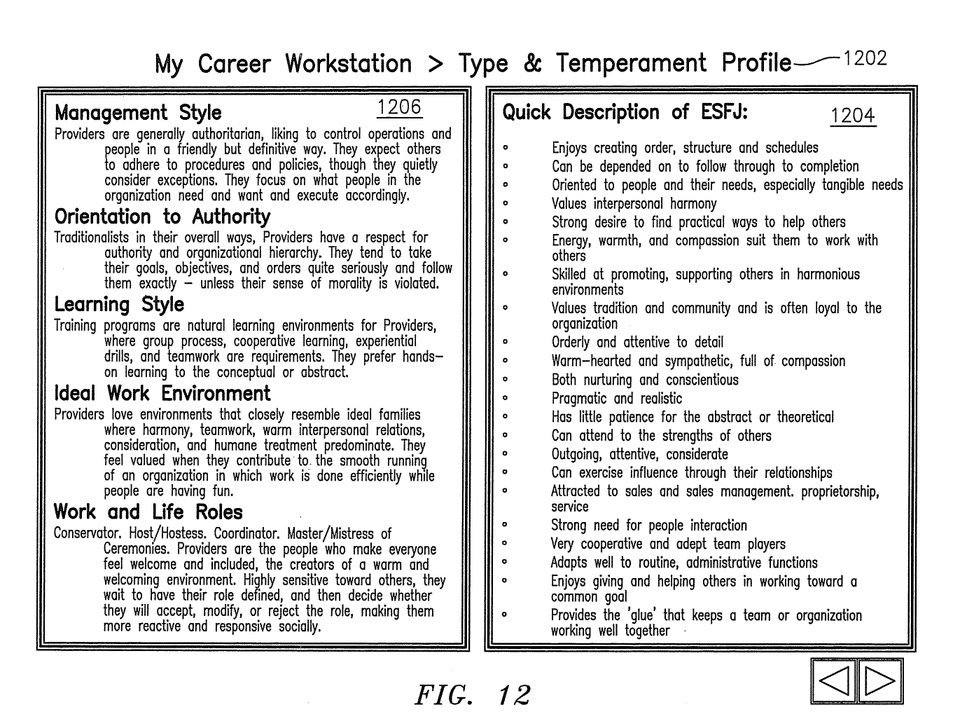

FIGS. 11 and 12 are exemplary user interface screens for displaying the results of the type and temperament game to the user. The results may be displayed in English or any other preferred language of the user. The user interface screen 1102 in FIG. 11 summarizes the personality of the user as determined by the type and temperament game. FIG. 12 is an alternate exemplary embodiment of a user interface screen for describing roles 1206 and summarizing qualities 1204 of a particular combination of type and temperament characteristics. The information depicted in FIG. 12 may apply to the user or it may be displayed to the user as a result of the user requesting information about the various type and temperament characteristic combinations. In the latter case, the user may scroll through descriptions for different combinations via the user interface 132.

In alternate exemplary embodiments, the type and temperament game determines less than four type and temperament characteristics of the user. In other alternate exemplary embodiments, the type and temperament game determines more than four type and temperament characteristics of the user. The type of type and temperament characteristics assessed may be modified based on individual users and/or implementation requirements.

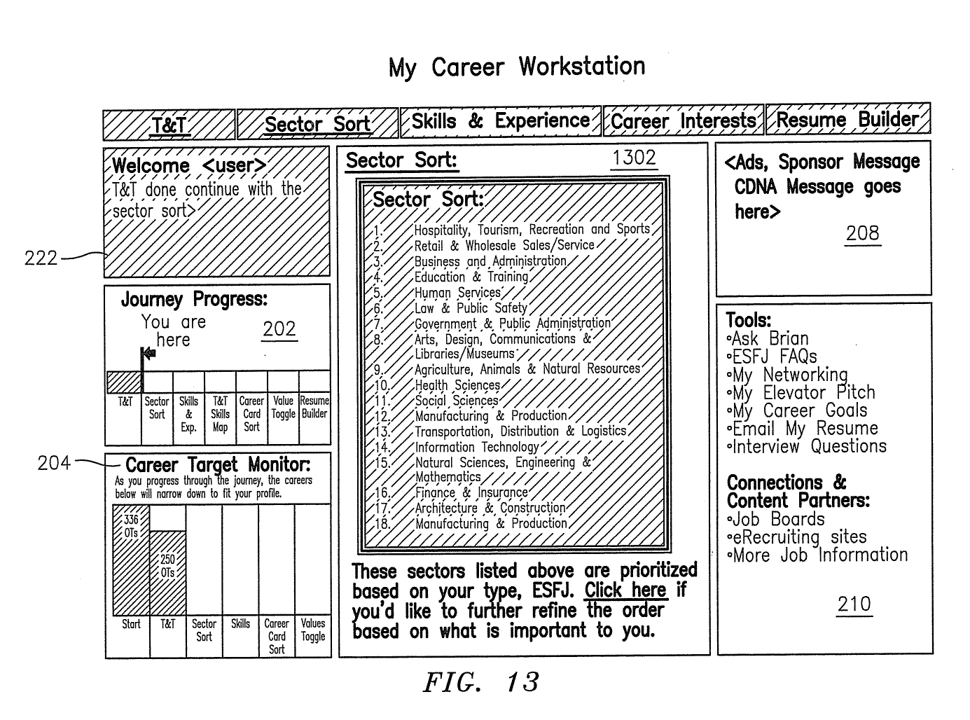

FIG. 13 is an exemplary user interface screen for providing the user with information about progress through the career management software after the user has completed the type and temperament game. It includes information from the workstation module 104 such as the journey progress chart 202 and the career target monitor 204. In addition, the user can access other portions of the software (sector sort, skills, career interests, resume builder) via the tool bar. In the example depicted in FIG. 13, the user has completed the type and temperament game (as indicated in the journey progress chart 202) and has narrowed the number of potential OTs down to two hundred and fifty (as indicated in the career target monitor 204). FIG. 13 also includes a preliminary sector sort 1302 that has been performed by a sector sort module 110 in the career management software based on user characteristics as determined by the type and temperament game. The user has the capability to change the order (perform sector sorting) via the user interface 132. Sector sorting includes having the user indicate preferred sectors as well as sectors that the user wants to avoid. The sectors presented on the screen may be related only to the remaining OTs associated with the user, or alternatively may include all of the sectors reflected in the job taxonomy database 122. In exemplary embodiments, the list of sectors initially presented to the user is based on the type and temperament characteristics of the user as determined by the type and temperament game. Sector sorting results in narrowing down the number of OTs associated with the user. In addition, sector sorting results in a sector profile for the user being updated. The user may access the sector profile via the user output files interface 134.

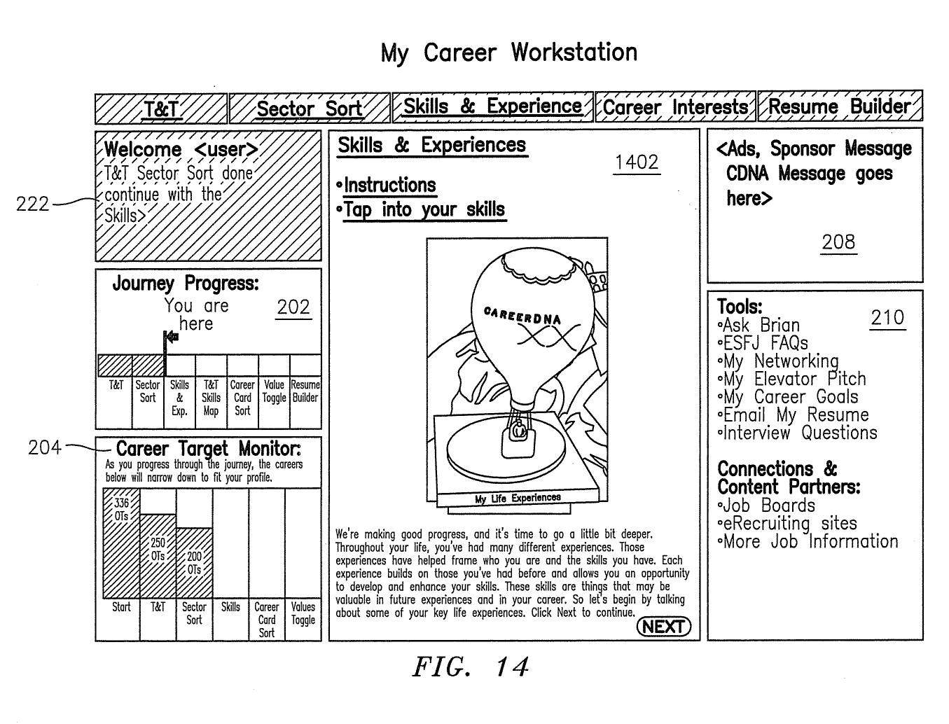

FIG. 14 is an exemplary user interface screen for providing the user with information about progress through the career management software after the user has completed the sector sort. It includes information from the workstation module 104 such as the journey progress chart 202 and the career target monitor 204. In the example depicted in FIG. 14, the user has completed the sector sort (as indicated in the journey progress chart 202) and has narrowed the number of potential OTs down to two hundred (as indicated in the career target monitor 204). FIG. 14 also includes a content panel 1402 with a graphical introduction to the skills and experiences game. When the user selects next, the skills and experiences module 112 in the career management software is invoked. Other and/or additional introductory user interface screens may be presented to the user via the user interface 132 to describe the skills and experiences game.

The narrowing down of the potential OTs may be implemented by matching sector characteristics of the user with sector characteristics associated with the OTs and JTs in the job taxonomy database 122. In exemplary embodiments, the job taxonomy database 122 includes sector characteristics associated with the OTs and/or JTs. The OTs and JTs (that still remain after the after the narrowing down by the previous games) that have characteristics that match and/or that are closest and/or meet some other match criteria when compared to the sector characteristics in the sector profile remain on the list of possible OTs and JTs for the user.

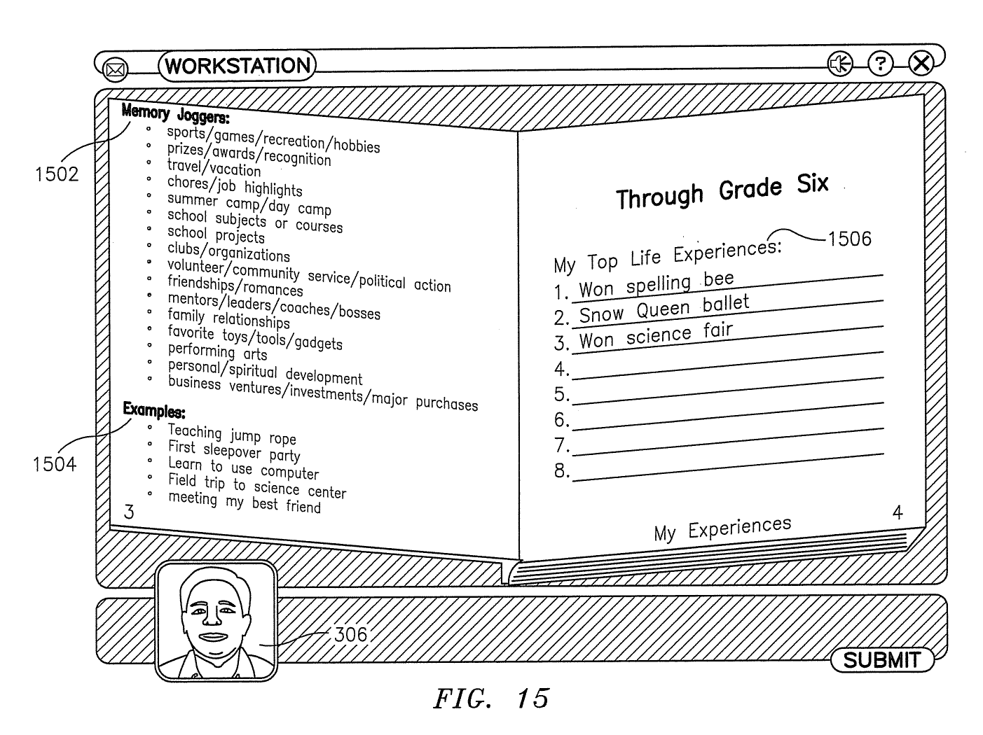

FIG. 15 is an exemplary user interface screen for the skills and experiences game in the career management software. The user is prompted to enter up to eight highlight experiences 1506 for different life phases (in this example, through grade six). A memory jogger 1502 and examples 1504 are provided for users in case they have trouble remembering highlights. Typically, the skills and experiences module 112 presents the user with user interface screens, via the user interface 132, to enter highlights for two or more life phases (e.g., through grade six, seventh grade through high school graduation, after high school to present, after high school to thirty, etc.). The number of life phases, the number of highlight experiences, and/or the content of the memory jogger may vary between users, groups of users and/or implementations.

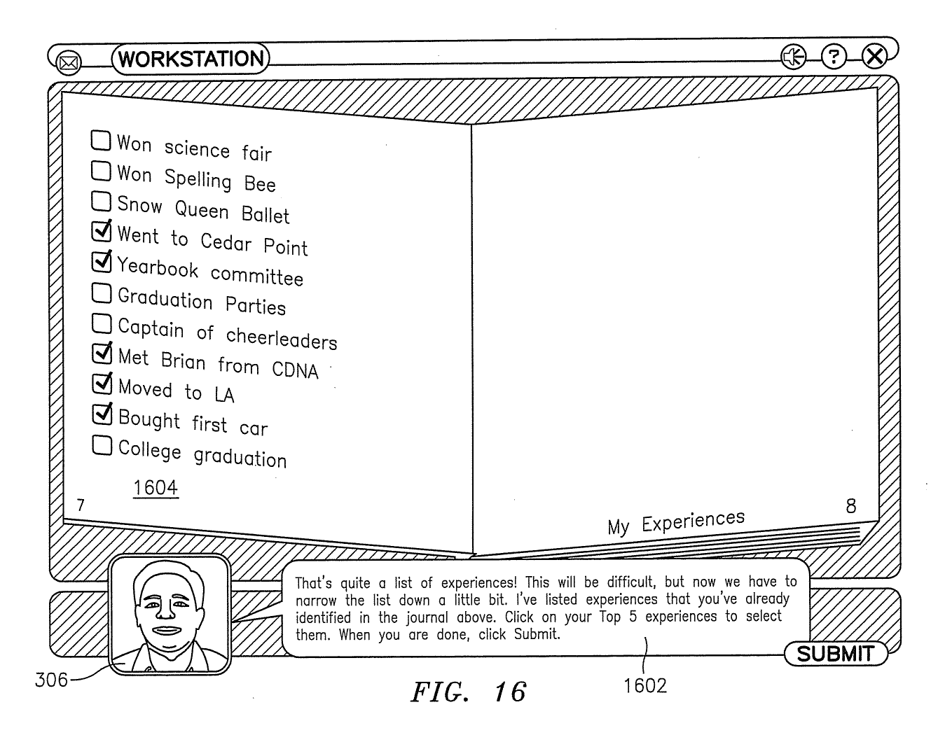

In the exemplary user interface screen depicted in FIG. 16, the user is prompted 1602 to select the top five life experiences from all of the highlight experiences previously entered. As shown in the control panel 1604 depicted in FIG. 16, the user clicks on a selection box next to his top five life experiences. Again, exemplary embodiments support prompting for less than five and more than five top experiences.

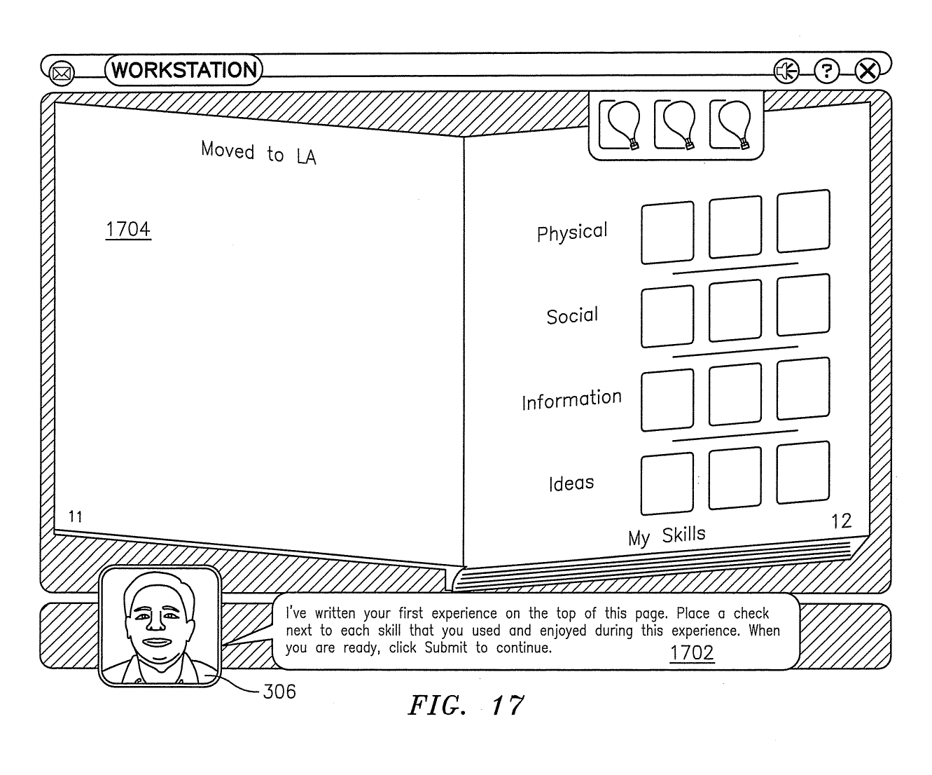

In FIG. 17, the user is prompted 1702 by the coach 306, to categorize each of his top five experiences into one or more skill categories that include: physical, social, information, and ideas. As depicted in the user interface of FIG. 17, a content panel 1704 includes the name of the experience (“moved to LA”), skill categories, and markers (balloons in this example) to move into the skill categories. The categories are intended to be exemplary in nature and different categories may be implemented by exemplary embodiments. In addition, a user interface describing these different categories and criteria for selecting them may be presented to the user. Once the user has performed the processing depicted in FIG. 17 for each of his top experiences, a summary user interface screen may be presented to the user. The summary may include the number of times each skill category was utilized by the top experiences.

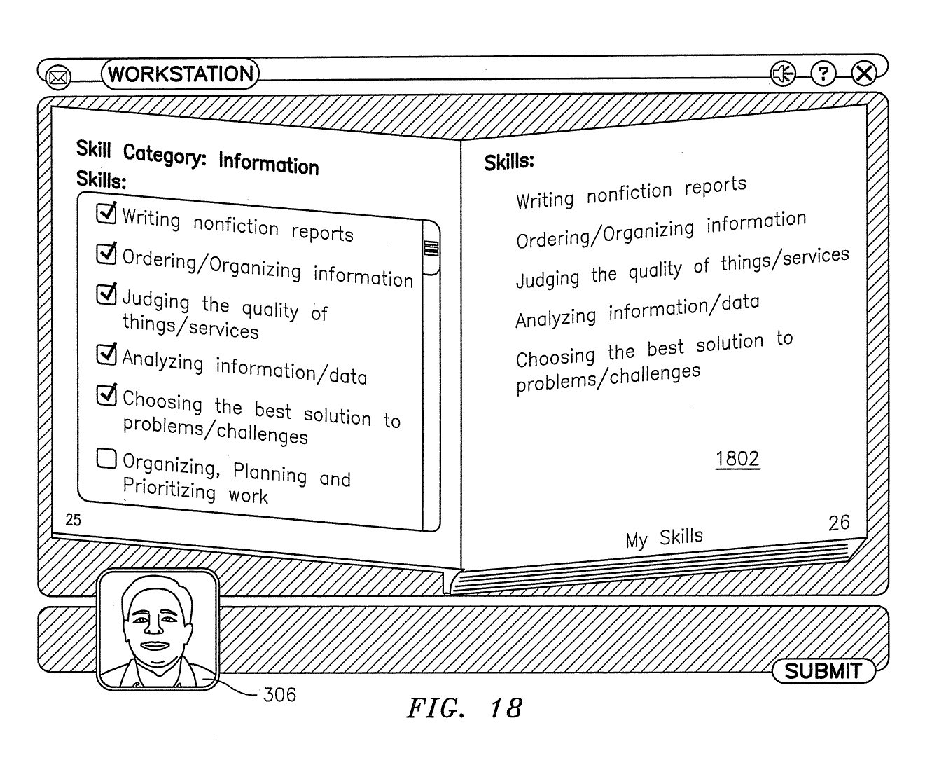

FIG. 18 is an example user interface screen for the skills and experiences game where the user selects skills in the information skill category that best represent the skills used in the user's top experiences (as identified in the user interface screen depicted in FIG. 16). The content panel 1802 of the user interface screen describes typical skills within the information skill category and prompts the user to select those that best represent skills used in the user's top experiences. In exemplary embodiments, a similar user interface screen is presented by the skills and experiences module 112 via the user interface 132, for each of the other skill categories depicted in FIG. 17.

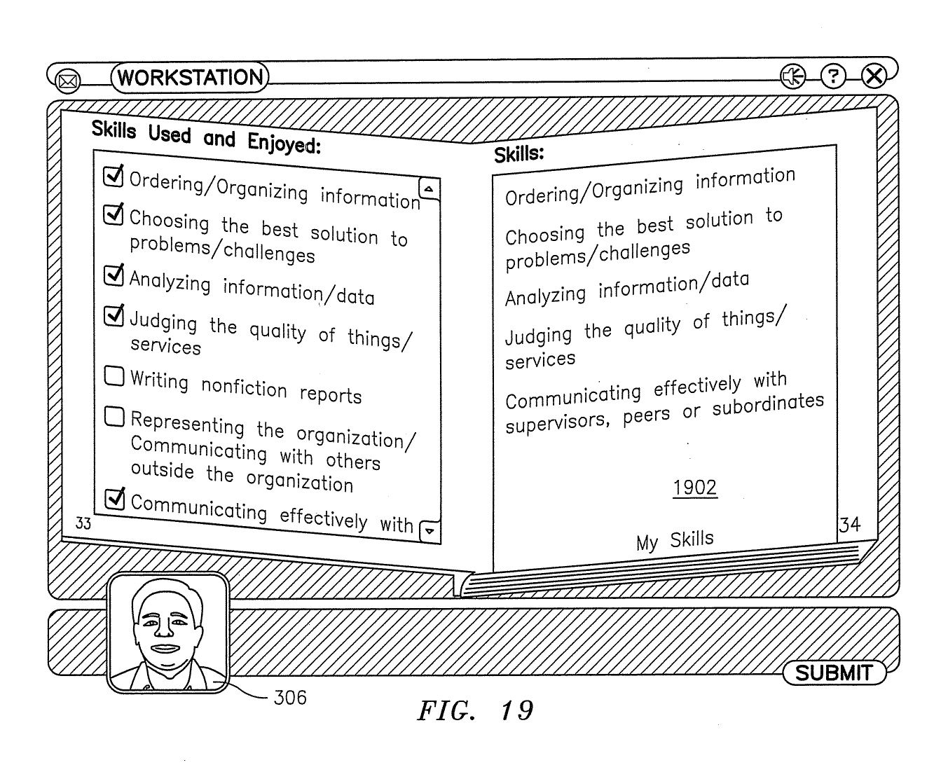

FIG. 19 is an exemplary user interface screen for the skills and experiences game where the user is prompted, in the content portion 1902 of the user interface screen, to select the skills that he thinks best describe him (the user). In exemplary embodiments, the user is prompted to select the skills that he thinks best describe him and that he most enjoys using. In this manner, the skills and experiences game identifies transferable skills. As used herein, the term “transferable skills” refers to skill which a person has had with them since childhood even if they have done nothing formal to develop those skills. Transferable skills can be moved around from one work or life situation to another and come in four basic categories: people or diplomatic skills, strategic or analytical skills, action or tactical skills, and administrative or logistical/scheduling skills. Transferable skills include skills such as organizing information, analyzing information, and communicating effectively. Transferable skills can be contrasted to technical/content skills which are skills for which a person needs formal and conscious training and that are specific to a discipline, piece of equipment, etc. Technical/content skills include skills such as a foreign language, using specific computer applications or operating systems, a specific laboratory technique, and an accounting procedure.

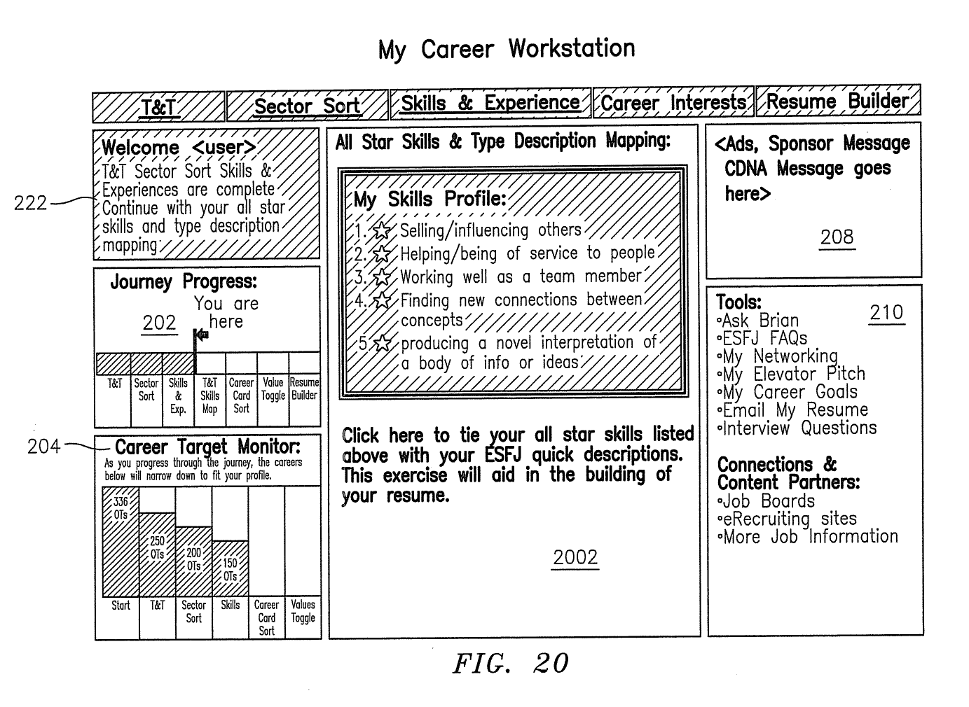

FIG. 20 is an exemplary user interface screen for providing the user with information about progress through the career management software after the user has completed the skills and experiences game. It includes information from the workstation module 104 such as the journey progress chart 202 and the career target monitor 204. In the example depicted in FIG. 20, the user has completed the skills and experiences game (as indicated in the journey progress chart 202) and has narrowed the number of potential OTs down to one hundred and fifty (as indicated in the career target monitor 204). FIG. 20 also includes a content panel 2002 that includes the results of the skills and experiences game. FIG. 20 displays the results of the skills and experiences game and summarizes the skills (also referred to herein as skills characteristics) with the best fit for the user. Because the user selects the top experiences and skills, the skills and experiences game is a self-validating game. The user's own recall and decoding of specific experiences is utilized as input for selecting occupational themes and preferred skills to find the right job. Other and/or additional summary user interface screens may be presented to the user via the user interface 132 to describe the results of skills and experiences game. In addition, the content panel 2002 prompts the user to tie his skills with his type and temperament characteristics. This can assist the user in building a resume by allowing the user to drag key phrases from his skills and types and temperament characteristics into the draft resume.

Output from the skills and experiences game includes updating a skills and experiences profile associated with the user. In exemplary embodiments, this output is utilized to narrow down the list of possible OTs and JTs that may be fits for the user. The narrowing down may be implemented by matching skills characteristics of the user with skills characteristics associated with the OTs and JTs in the job taxonomy database 122. In exemplary embodiments, the job taxonomy database 122 includes skills characteristics associated with the OTs and/or JTs. The OTs and JTs (that still remain after the after the narrowing down by the previous games) that have characteristics that match and/or that are closest and/or meet some other match criteria when compared to the skills characteristics in the skill profile remain on the list of possible OTs and JTs for the user.

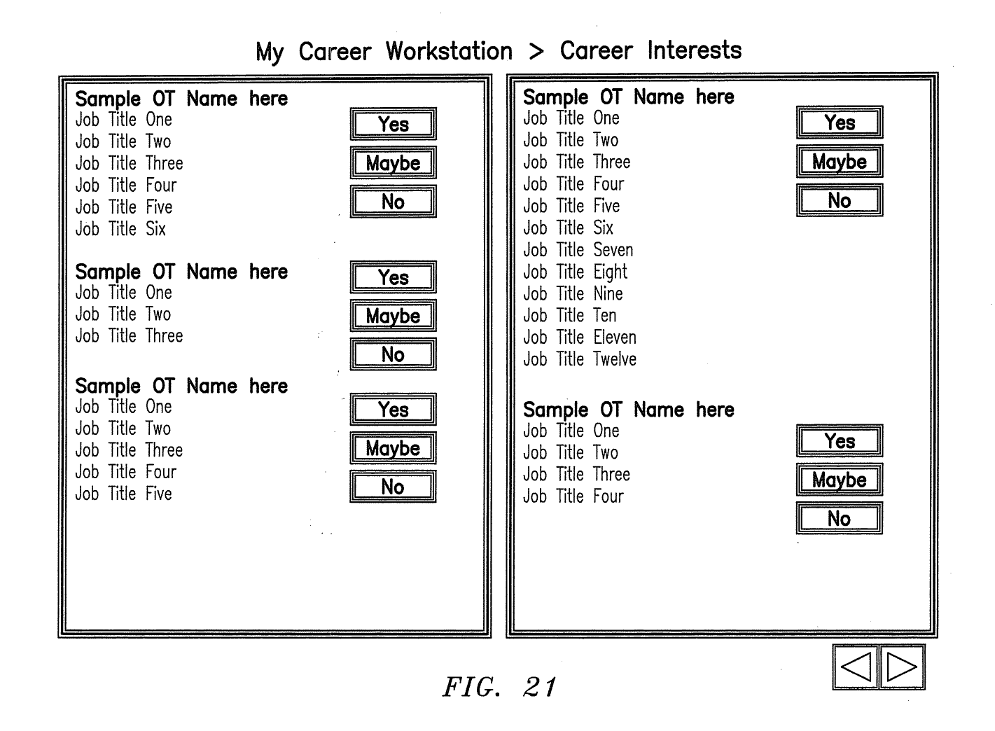

Next, the user will be asked to identify career interests by playing the career interests card sort game that is executed by the career interests module 116 in the career management software. FIG. 21 is an exemplary user interface screen for performing the defining occupational interests portion of the career interests card sort game. It includes the list of OTs that appear to be possibilities for the user based on the previous games played by the user and allows the user to select those that seem most interesting. Once this is completed, the user may be presented with a summary screen, showing, for example, the top ten occupational themes for the user. In addition the summary screen may show that the user has completed the career interests card sort game (as indicated in the journey progress chart 202) and has narrowed the number of potential OTs down still further (as indicated in the career target monitor 204). In exemplary embodiments, the output from the career interests game, the career interests characteristics, is stored in a career interests profile for the user. In exemplary embodiments, the narrowing down occurs by matching the interests of the user to data contained in the job taxonomy database 122.

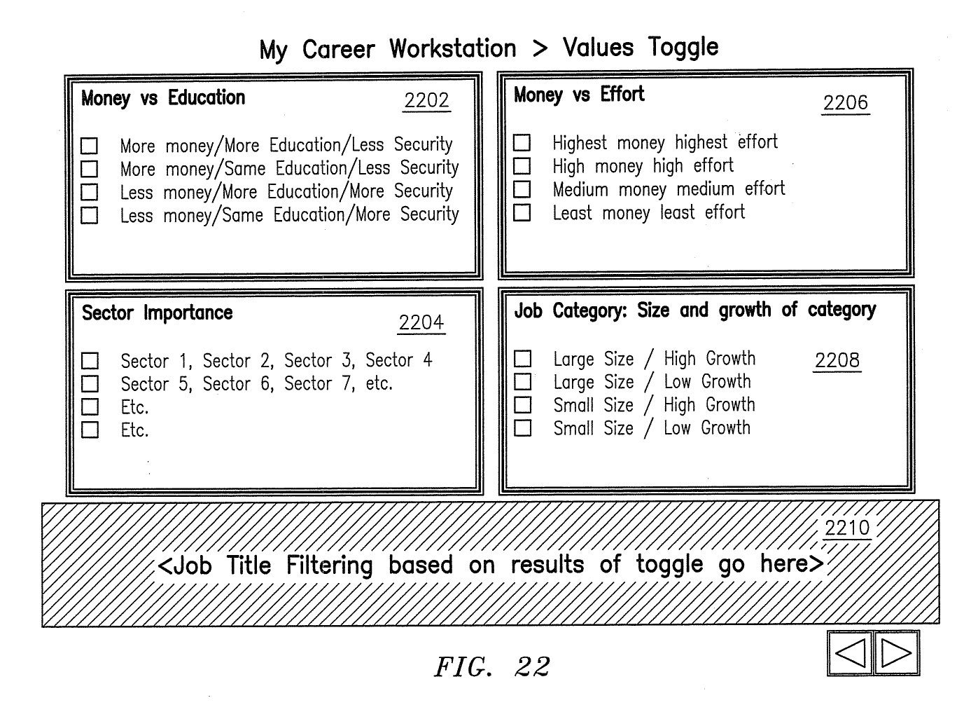

FIG. 22 is an exemplary user interface screen for identifying values that are important to the user. The values toggle game is executed by a values toggle module 118 that is part of the career management software. Examples include a money vs. education toggle 2202, a money vs. effort toggle 2206, a sector importance toggle 2204, and a job category toggle 2208. The user is prompted to select value toggles on the screen. In this manner, the user registers his own values towards occupational variables, and occupations are presented to fit those preferences (i.e., the JTs and OTs are narrowed down based on the user's values). In exemplary embodiments, this occurs as a dynamic interaction between the user values and the job taxonomy database 122. When the user changes the relative emphasis of occupational, circumstantial and/or values, the menu 2210 of suggested occupations, or job titles, changes accordingly.

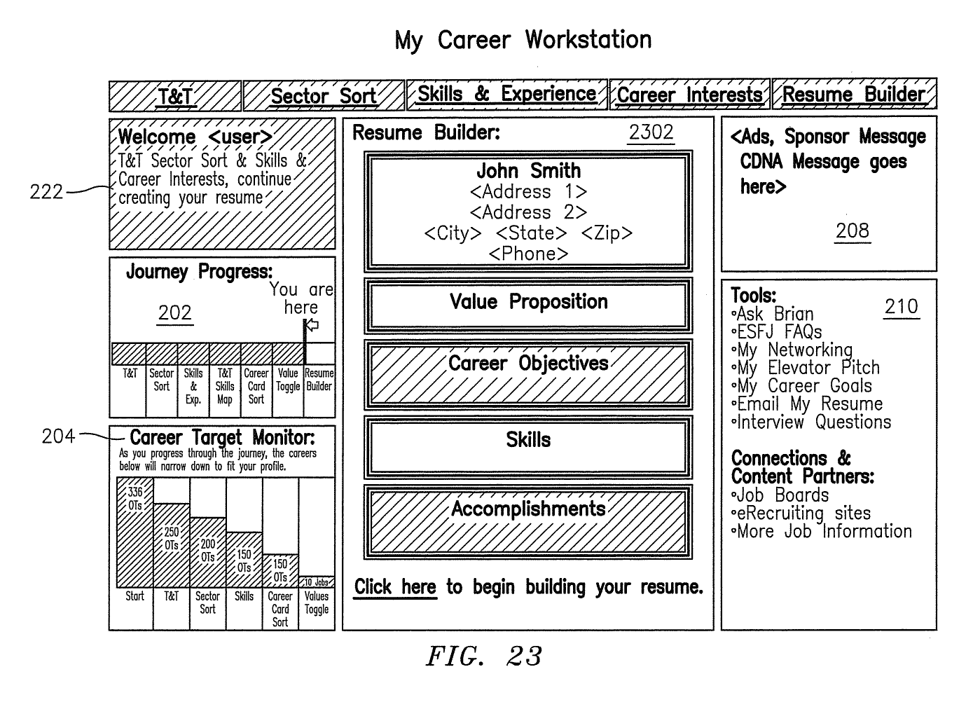

FIG. 23 is an exemplary user interface screen for providing the user with information about progress through the career management software after the user has completed the values toggle game. It includes information from the workstation module 104 such as the journey progress chart 202 and the career target monitor 204. In the example depicted in FIG. 23, the user has completed the values toggle game (as indicated in the journey progress chart 202) and has narrowed the number of potential OTs down to ten jobs (as indicated in the career target monitor 204). FIG. 23 also includes a content panel 2302 with an introduction to a resume builder portion of the career management software. When the user selects “click here”, the resume builder module 120 in the career management software is invoked. Other and/or additional introductory user interface screens may be presented to the user via the user interface 132 to describe the resume builder.

The resume builder may present screens, via the user interface 132, to the user summarizing the data collected by the career management software tool in one or more of the type and temperament game, the sector sort, the skills and experiences game, the career interests card sort game, and the values toggle. This is an example of cross pollination, where the outputs from individual modules are co-presented so that the user can identify themes and patterns. In addition, the user may be prompted to list education, achievements, current employer and job/achievements, and previous employers and jobs/achievements.

One or more additional user interface screens may be presented to the user to obtain user feedback about the career management software.

The user interface screens depicted herein are intended to be exemplary in nature. As will be appreciated by those skilled in the art, a variety of user interface formats and process flows may be utilized to assist the user in the self-knowledge and career management process.

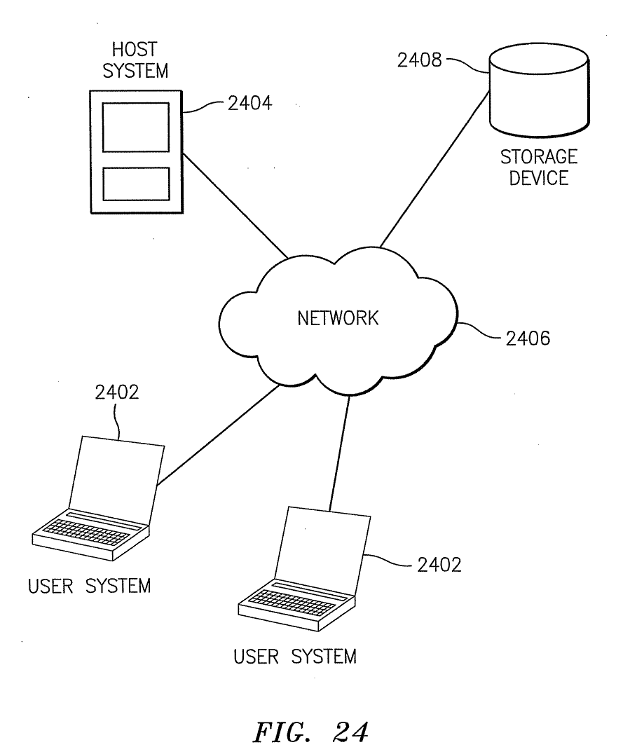

FIG. 24 is a block diagram of an exemplary system for providing self-knowledge and career management. The system depicted in FIG. 24 includes one or more user systems 2402, through which users at one or more geographic locations may contact the host system 2404 to perform self-knowledge and career management. The host system 2204 executes computer instructions for performing the self-knowledge and career management process as described herein (referred to herein as “career management software”). The user systems 2402 are coupled to the host system 2404 via a network 2406. Each user system 2402 may be implemented using a general-purpose computer executing a computer program for carrying out the processes described herein. The user systems 2402 may be implemented by personal computers and/or host attached terminals. If the user systems 2402 are personal computers (or include functionality execute the processing described herein), the processing described herein may be shared by a user system 2402 and the host system 2404 (e.g., by providing an applet to the user system).

The network 2406 may be any type of known network including, but not limited to, a wide area network (WAN), a local area network (LAN), a global network (e.g. Internet), a virtual private network (VPN), and an intranet. The network 2406 may be implemented using a wireless network or any kind of physical network implementation. A user system 2402 may be coupled to the host system 2404 through multiple networks (e.g., intranet and Internet) so that not all user systems 2402 are coupled to the host system 2404 through the same network. One or more of the user systems 2402 and the host system 2404 may be connected to the network 2406 in a wireless fashion.

The storage device 2408 includes the job taxonomy database 122, the user output files that include user characteristic data (e.g., user profiles such as the type and temperament profile) and any other data related to the self-knowledge and career management functions. Additional data stored on the storage device 2408 tracks the progress of each user through the career management process and any interim data so that users can exit the career management tool and return at a later time. The storage device 2408 may be implemented using a variety of devices for storing electronic information. It is understood that the storage device 2408 may be implemented using memory contained in the host system 2404, a user system 2402, or it may be a separate physical device. The storage device 2408 is logically addressable as a consolidated data source across a distributed environment that includes a network 2406. Information stored in the storage device 2408 may be retrieved and manipulated via the host system 2404 and/or via one or more user systems. In exemplary embodiments of the present invention, the host system 2404 operates as a database server and coordinates access to application data including data stored on the storage device 2408.

The host system 2404 depicted in FIG. 24 may be implemented using one or more servers operating in response to a computer program stored in a storage medium accessible by the server. The host system 2404 may operate as a network server (e.g., a web server) to communicate with the user systems 2402. The host system 2404 handles sending and receiving information to and from the user system 2402 and can perform associated tasks. The host system 2404 may also include a firewall to prevent unauthorized access to the host system 2404 and enforce any limitations on authorized access. A firewall may be implemented using conventional hardware and/or software as is known in the art.

The host system 2404 may also operate as an application server. The host system 2404 executes one or more computer programs to implement the self-knowledge and career management functions described herein. The computer programs are referred to collectively as the career management software or as the career management software tool. The career management software may include, but is not limited to, a type and temperament module 108, a sector sort module 110, a skills and experiences module 112, a career interests module 116, a values toggle module 119, a resume builder module 120, a skills alignment module, and an action plan module 106. Processing may be shared by the user system and the host system 2404 by providing an application (e.g., java applet) to the user system. The computer programs are referred to collectively herein as the career management software.

Alternatively, the user system can include a stand-alone software application for performing a portion or all of the processing described herein. As previously described, it is understood that separate servers may be utilized to implement the network server functions and the application server functions. Alternatively, the network server, the firewall, and the application server may be implemented by a single server executing computer programs to perform the requisite functions.

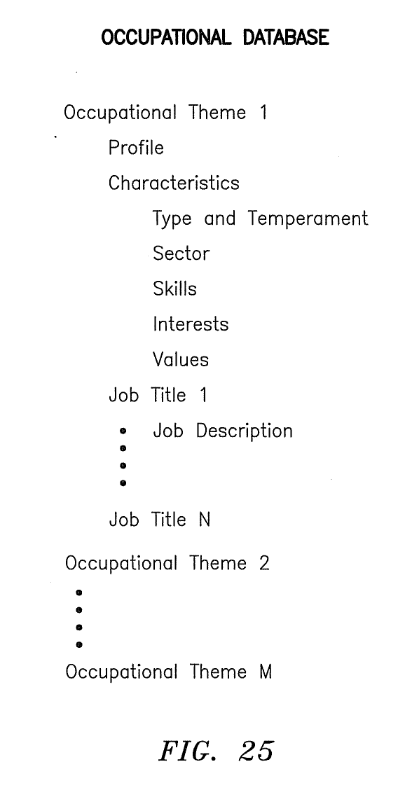

FIG. 25 depicts contents of an exemplary job taxonomy database 122 that may be stored in the storage device 2408 and utilized by the career management software. It includes a plurality of occupational themes (e.g., professional investor/investment professional and business owners/entrepreneurs/general managers). Occupational themes refer to large categories of job titles that share common skills, tasks, education requirements and work activities. In the previous example depicted in FIG. 1, the college graduate job taxonomy database 122 has three hundred and thirty six occupational themes. Each occupational theme has one or more associated job titles. For example, the occupational theme professional investor/investment professional may be associated with job titles such as joint hedge fund manager and joint venture capitalist, and the occupation theme business owners/entrepreneurs/general managers may be associated with job titles such as business owner software company, business owner restaurant. Data stored for each job title includes, but is not limited to a job description. Data stored for each occupational theme includes one or more of an occupational profile describing the occupational theme, type and temperament characteristics best suited for the occupational theme, the sector associated with the occupational theme, skills (or skill characteristics) required for the occupational theme, career interests (or career interests characteristics) associated with the occupational theme and values (or values characteristics) associated with the occupational theme. Any of the data values may be stored in the job taxonomy database 122 or be derived from data stored in the job taxonomy database 122 or elsewhere. The job taxonomy database 122 depicted in FIG. 25 is exemplary in nature, and other embodiments including other data and formats may also be utilized by exemplary embodiments.

As described previously, alternate exemplary embodiments are directed to use by employees of a corporation to develop career plans and development actions based on employee skills and the critical skills required by particular occupations within the corporation. This can assist an employer in finding the best employee for a particular position and/or to provide targeted training for existing employees. In addition, the corporation may have prospective employees utilize the career management software to determine best candidates for particular job positions within the corporation. In these embodiments, the job taxonomy database 122 may include job positions available within the corporation (all or only those with a current opening) and a list of critical skills associated with each job position.

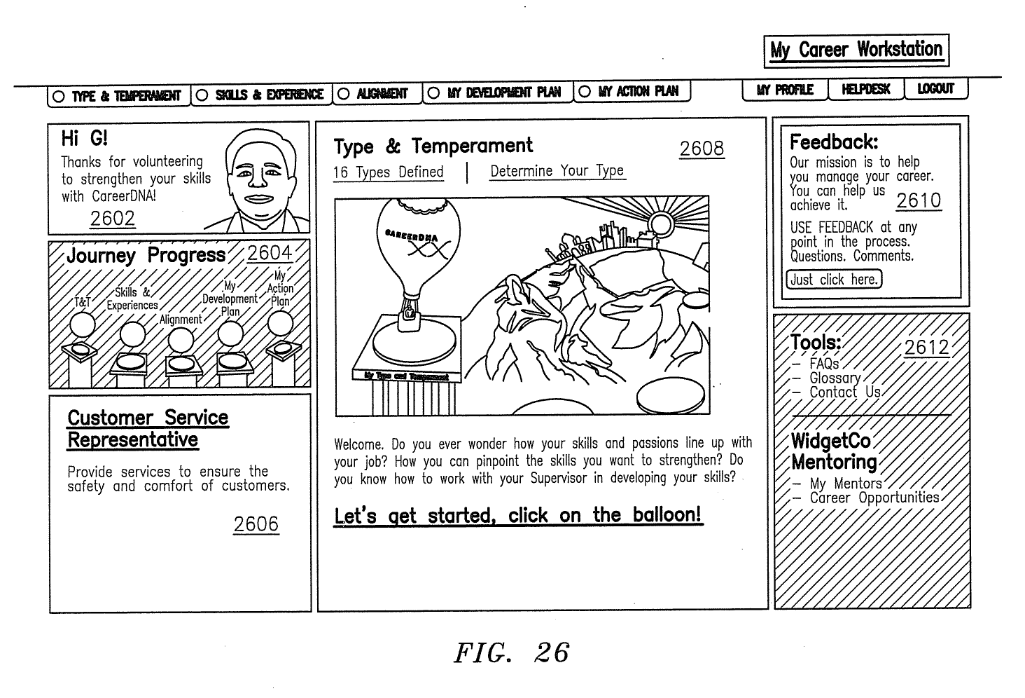

FIG. 26 depicts an exemplary user interface screen for providing employee access to a career management software tool tailored to a specific corporation. It is similar to the user interface screens described previously but includes a subset of the modules and a job taxonomy database 122 directed to job positions with the corporation. The user message area 2602 welcomes the user to the career management software. In this example, the user will be lead through both the type and temperament game, and the skills and experiences game as described previously. Then the user will be lead through a skills alignment game, implemented by a skills alignment module that will compare the current skills of the employee to critical skills required for the present job position of the employee. Alternatively, the employee skills could be compared to critical skills required for a job position that the employee would like to have in the corporation. Based on the results of the skills alignment, the employee is assisted in creating a development plan and an action plan.

The content panel 2608 in the user interface screen depicted in FIG. 26 includes a graphical introduction to the type and temperament game. The user interface screen depicted in FIG. 26 also includes a feedback panel 2610, a tools panel 2612, a journey progress panel 2604, and a job title panel 2606. After completing the type and temperament game, as described previously, the user performs the skills and experiences game. The skills and experiences game may be performed in the same manner as that described previously. Alternatively, or in addition to, the skills and experiences game may determine employee skills by presenting the employee with a user interface listing possible skills and asking the employee to rate each one as “passionately used”, “used and enjoyed” or “not used or enjoyed.” The employer could then be presented with a list of his top skills and a list of those skills that he passionately enjoyed.

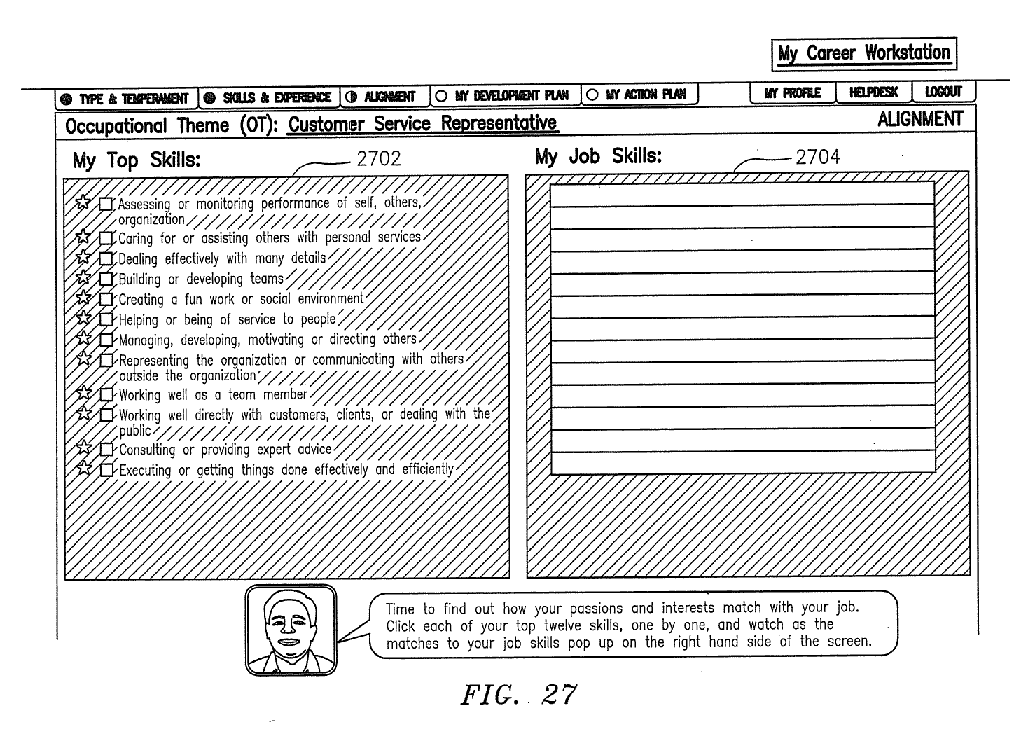

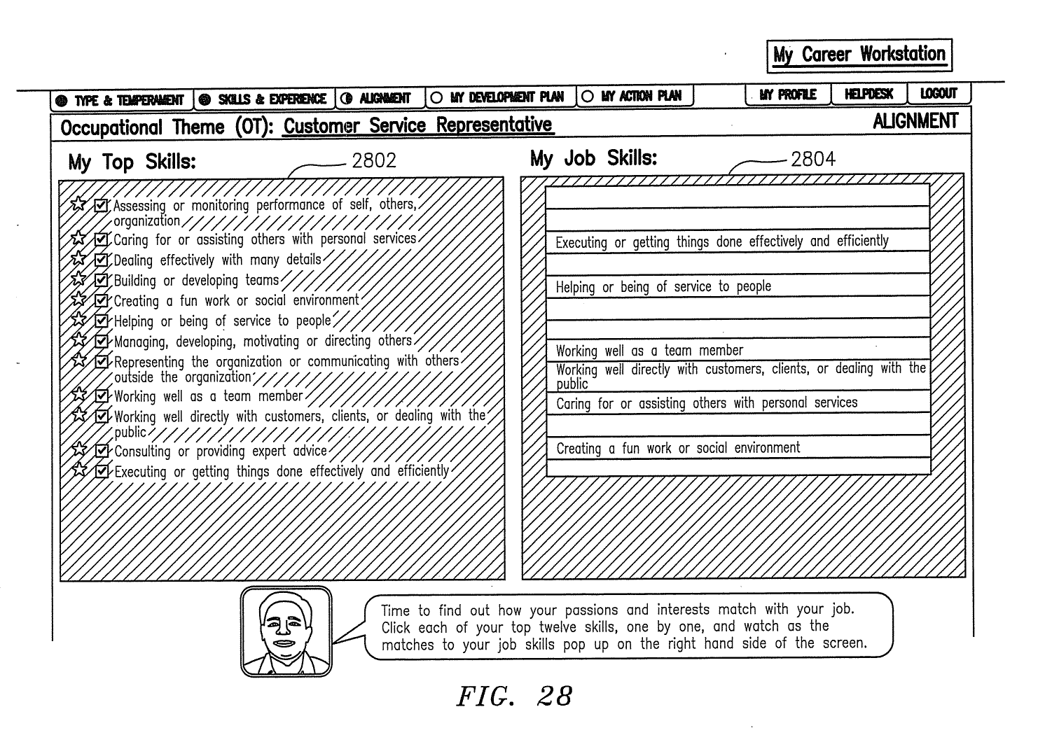

FIG. 27 depicts an exemplary user interface for listing the top skills of an employee based on the output of the skills and experiences game. As depicted in FIG. 27, the employee's top skills are listed in block 2702, while block 2704 is blank. The user is instructed to select each of the skills listed in block 2702 to determine if the selected skill corresponds to a critical skill required for the job position. FIG. 28 depicts an exemplary user interface for comparing the skills of an employee to critical skills for the job position. In the example depicted in FIG. 28, six of the employee's top skills listed in block 2802 are considered to be critical job skills for the job position as indicated by their presence in block 2804.

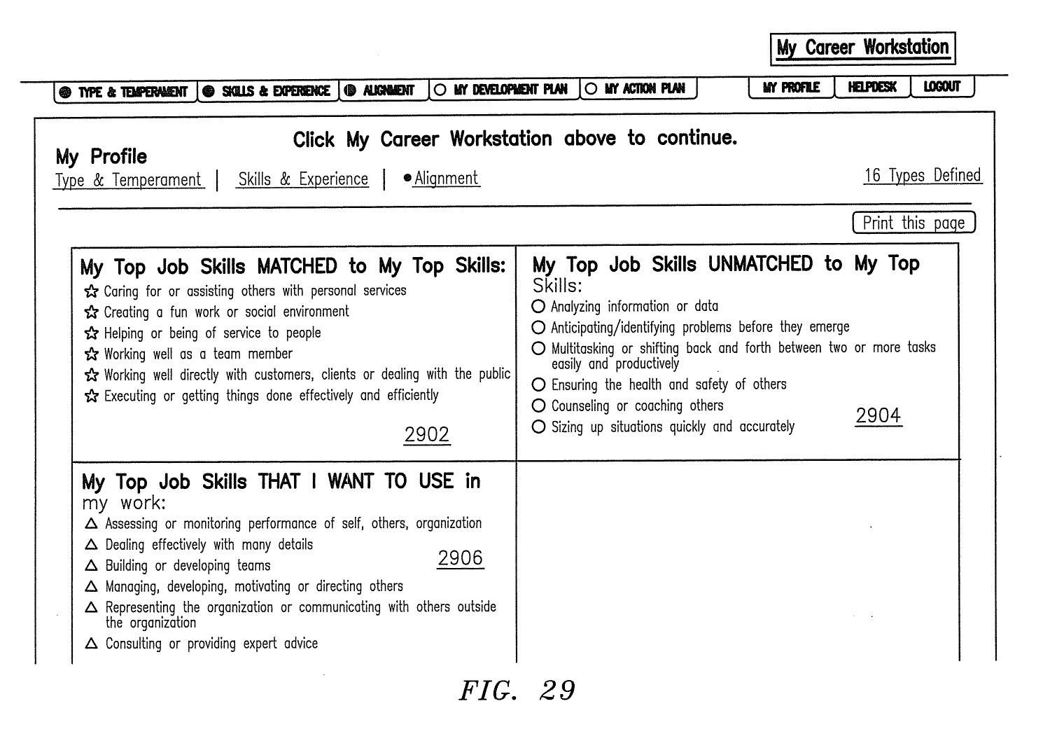

Then, as depicted in FIG. 29, a sort is performed and presented to the user to highlight the skills possessed by the employee that are critical skills for the employee's current (or future) job position 2902, what critical skills the employee is lacking for his current (or future) job position 2904, and what skills would the employee like to be using in his ideal job position (e.g., skills passionately enjoyed by the employee) 2906.

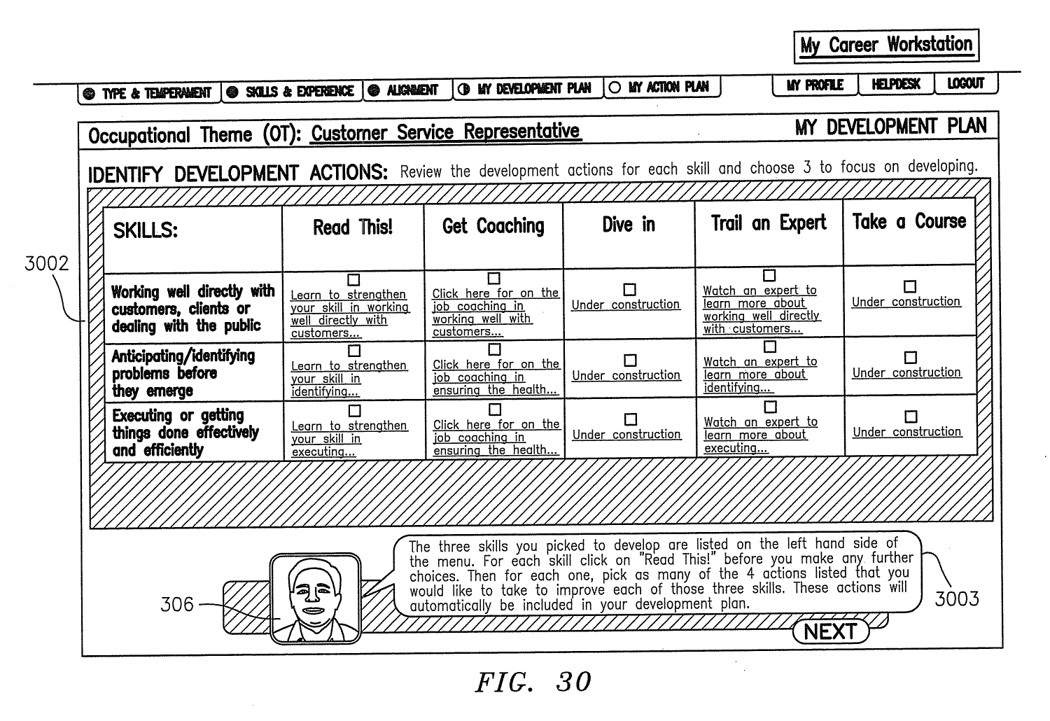

The employee could then be stepped through creating an employee development plan. FIG. 30 depicts an exemplary user interface screen for creating an employee development plan. For each skill that the employee is lacking for his current job position, several development options are presented. Development options may include, but are not limited to, one or more of coaching, hands on experience, trailing an expert and taking a course. In exemplary embodiments, a minimum defined percentage (e.g., 50%, 70%) of the development options presented are those that are employee initiated or employee controlled, thus allowing the employee to take an active role in his employee development. The employee is prompted 3003 by the coach 306 to select from the options in the content panel 3002. The employee selections are then included in the employee development plan.

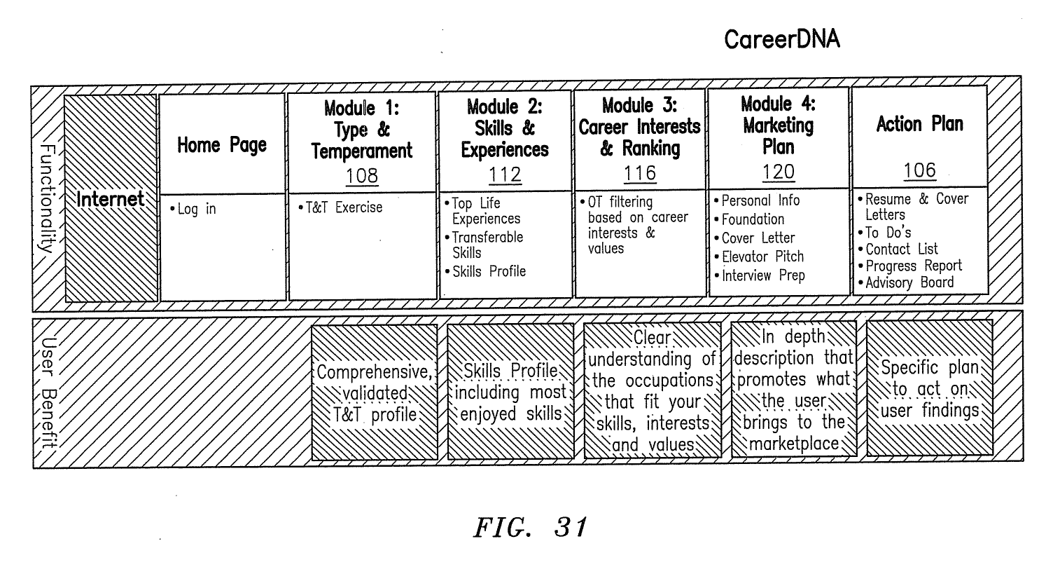

FIGS. 31-34 contain example process flows that may be implemented by exemplary embodiments of the career management software tool. Other process flows may be implemented and presented to the user by combining all or a subset of the modules in the career software management tool in a different order. The career management software tool is modular so that it can easily accommodate different combinations and orderings of the modules.

FIG. 31 is a block diagram of a process that may be implemented by exemplary embodiments of the career management software to facilitate self-knowledge and career management. As depicted in FIG. 31, the user accesses a home page of the career management software via a network 2406, such as the Internet. When the user logs on to the career management software, the user interface 132 to the career management software tool is provided to the user. The embodiment of the career management software tool depicted in FIG. 31 includes the type and temperament module 108 (“Module 1” in FIG. 31), the skills and experiences module 112 (“Module 2” in FIG. 31), and the career interests module 116 (“Module 3” in FIG. 31). In the embodiment depicted in FIG. 31, the career management software also includes the resume builder module 120 (“Module 4” in FIG. 31) and the action plan module 106 (“Action Plan” in FIG. 31). As described previously herein, the modules include illustrated scenarios as a form of stimuli. In addition, the modules receive information from the user via the user interface 132 and perform user validation including altering the screen flow in response to the information received from the user.

Referring to FIG. 31, the type and temperament module 108 is executed to determine type and temperament characteristics of the user and results in a validated type and temperament profile. The type and temperament profile may be utilized by the user to further his own self-knowledge. Alternatively, or in addition, the type and temperament profile may be utilized by a supervisor or teammate of the user to better understand the personality of the user. A first set of records from the job taxonomy database 122 may be selected based on the determined type and temperament characteristics of the user. In an exemplary embodiment, the first set of records includes job taxonomy database records corresponding to occupational themes having characteristics that are the same (or compatible) with the determined type and temperament characteristics of the user. The job taxonomy database 122 also includes job titles associated with each of the occupational themes.

As shown in FIG. 31, the skills and experiences module 112 is then executed to determine skill characteristics of the user. Output from the skills and experiences module 112 includes a skills profile (also referred to herein as skills characteristics) of the user, including an identification of the skills most enjoyed by the user. A second set of records is chosen from the first set of records based on the skills profile of the user. Thus, the second set of records contains records from the job taxonomy database 122 that are compatible with both the type and temperament characteristics of the user and the skills characteristics of the user. The career interests module 116 is executed to determine career interest characteristics of the user. A third set of records is selected from the second set of records based on the career interests characteristics of the user. Thus, the third set of records contains records from the job taxonomy database 122 that are compatible with all three of the type and temperament, skills and career interests characteristics of the user. In addition, the sector sort module 110 and the values toggle module 118 may be executed to further reduce the number of occupational themes and job titles contained in the third set of records. All or a subset of the contents of the records in the third set are communicated to the user to provide the user with an understanding of the occupation themes that fit the skills, interests and values of the user.

As depicted in FIG. 31, the user may then execute the resume builder module 120 to create a marketing plan that includes an in depth description that promotes what the user brings to the market place. The marketing plan may include components such as, but not limited to, personal information, a foundation, a cover letter, an elevator pitch and interview preparation. The action plan module 106 is then executed to create a specific action plan for the user. The action plan may include components such as, but not limited to, a resume and cover letters, a list of action items, a contact list, a progress report and a list of possible coaches.

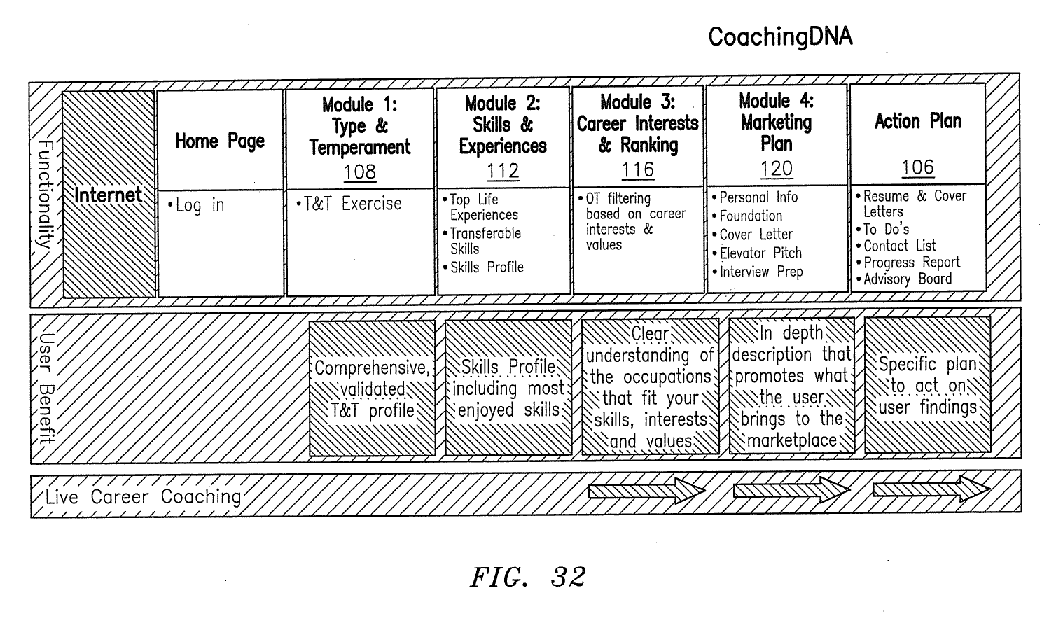

FIG. 32 is a block diagram of a process that may be implemented by exemplary embodiments to facilitate career coaching. The process flow depicted in FIG. 32 is the same as the process flow depicted in FIG. 31 with the addition of the arrows at the bottom indicating that live career coaching is occurring at all or a subset of the steps in the process. The coaching may be performed in an on-line (e.g., e-mail, video, video teleconference, etc.) or off-line manner (e.g., face-to-face meeting) and is responsive to output (e.g., profiles) from the career management software modules.

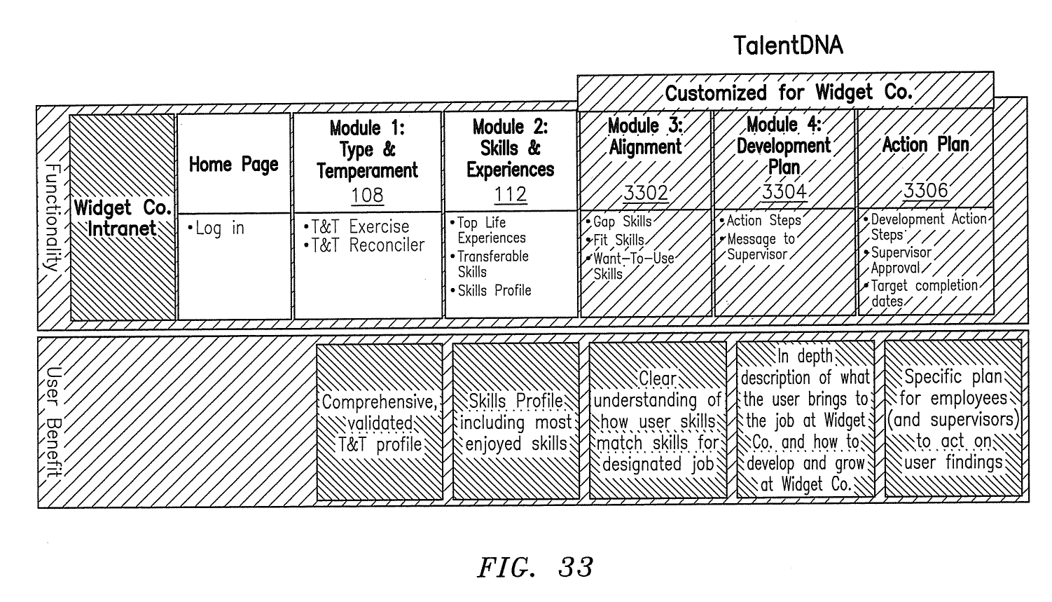

FIG. 33 is a block diagram of a process that may be implemented by exemplary embodiments to facilitate determining critical skills for a job position in a corporation. As depicted in FIG. 33, the user/employee accesses a home page of the career management software via a network 2406, such as a corporate Intranet. When the user logs on to the career management software, the user interface 132 to the career management software tool is provided to the user. The user interface 132 may be customized based on requirements of the corporation. The embodiment of the career management software tool depicted in FIG. 33 includes the type and temperament module 108 (“Module 1” in FIG. 33), the skills and experiences module 112 (“Module 2” in FIG. 33), an alignment module 3302 (“Module 3” in FIG. 33), a development plan module 3304 (“Module 4” in FIG. 33) and an employee action module 3306.

Referring to FIG. 33, the type and temperament module 108 is executed to determine type and temperament characteristics of the user and results in a validated type and temperament profile. The type and temperament module 108 utilizes a screen flow and illustrated scenarios to determine the type and temperament characteristics. User validation of the determined characteristics, or profile, is performed. As described previously herein, the user validation process may result in altering the screen flow based on information received from the user. The type and temperament profile may be utilized by the user to further his own self-knowledge. Alternatively, or in addition, the type and temperament profile may be utilized by a supervisor or teammate of the user to provide a better understanding of the personality of the user. As shown in FIG. 33, the skills and experiences module 112 is then executed to determine current skills of the user. The current skills may be categorized as one or more of physical skills, social skills, information skills and ideas skills. Output from the skills and experiences module 112 includes a transferable skills profile (also referred to herein as skills characteristics) of the user, including an identification of the skills most enjoyed by the user.

Referring to FIG. 33, the alignment module 3302 accesses a list of critical skills required for a job position. The job position may be a job position currently held by the user or a job position that the user would like to have sometime in the future. Critical skills reflect a subjective judgment (e.g., by a supervisor, by an employee in the job position, by another third party) about what skills are the most important skills for success in the job position. In this exemplary embodiment the job taxonomy database includes the critical skills associated with one or more job positions in the corporation. The alignment module 3302 compares the current skills of the user to the critical skills for the job position to determine if there is a mismatch. The development plan module 3304 assists the user in creating a development plan based on the gap between the critical skills and the employee skills. The development plan may then be communicated electronically to a supervisor of the user. Next, the employee action module 3306 is executed to assist the user in creating an action plan including specific actions to be taken by the user and/or the supervisor of the user in response to the development plan. In exemplary embodiments, most of the specific actions are things that are user initiated and user controlled (e.g., read a book, perform a task, enroll in a course, etc.).

In exemplary embodiments, the critical skills for a job position are created by analyzing the skills of users who are top performers in the job position. These users may currently hold the job position or may have held the job position in the past. The current skills of each of the users are determined by the skills and experiences module 112. In this embodiment, the skills and experiences module 112 also facilitates an evaluation by the user of the importance of each of the current skills to the job position. A list of critical skills for the selected job position is then created based on the current skills and evaluations of the users who are top performing in the job position. In an alternate exemplary embodiment, one or more supervisors of employees in the selected job position execute the skills and experiences module 112 and their results are utilized (alone or in combination with top performer results) to determine the critical skills for a selected job position. In an alternate exemplary embodiment, type and temperament characteristics of the top performers are also determined and associated with the job position.

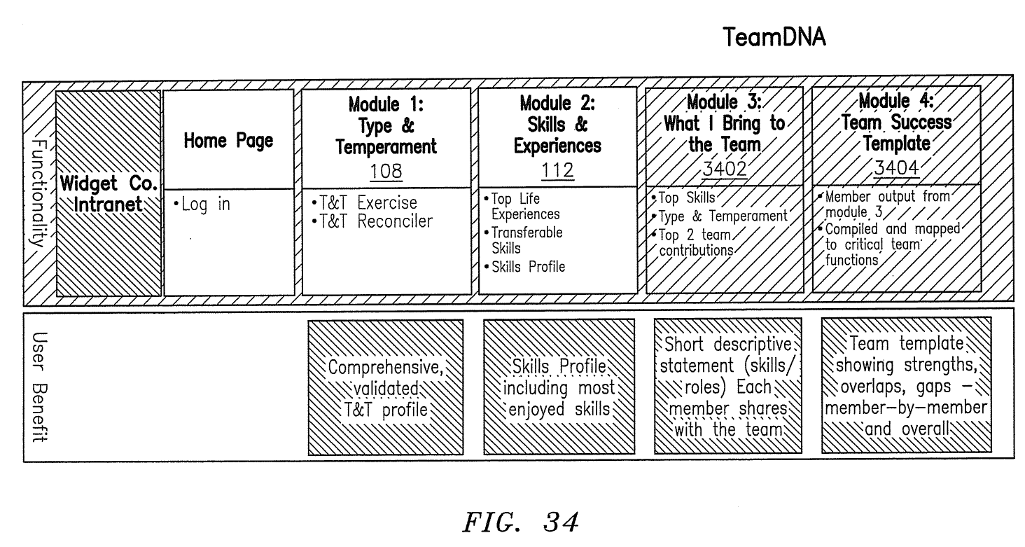

FIG. 34 is a block diagram of a process that may be implemented by exemplary embodiments to facilitate determining critical skills for a team. As depicted in FIG. 34, the user/employee accesses a home page of the career management software via a network 2406, such as a corporate Intranet. When the user logs on to the career management software, the user interface 132 to the career management software tool is provided to the user. The exemplary embodiment of the career management software tool depicted in FIG. 34 includes the type and temperament module 108 (“Module 1” in FIG. 34), the skills and experiences module 112 (“Module 2” in FIG. 34), a bring to the team module 3402 (“Module 3” in FIG. 34), and a team success template module 3404 (“Module 4” in FIG. 34).

Referring to FIG. 34, the type and temperament module 108 is executed by each of the team members to determine type and temperament characteristics of each of the team members. The type and temperament module 108 utilizes a screen flow and illustrated scenarios to determine the type and temperament characteristics. User validation of the determined characteristics, or profile, is performed. As described previously herein, the user validation process may result in altering the screen flow based on information received from the user. The type and temperament profile may be utilized by the user to further his own self-knowledge. As shown in FIG. 34, the skills and experiences module 112 is then executed to determine current skills of the team members. The current skills may be categorized as one or more of physical skills, social skills, information skills and ideas skills. Output from the skills and experiences module 112 includes a skills profile (also referred to herein as skills characteristics) of the user, including an identification of the skills most enjoyed by the user.

Referring to FIG. 34, the bring to team module 3402 facilitates the creation of a short descriptive statement summarizing the team member's skills and type/temperament for sharing with the team. By doing this, the team members better understand what personality traits and skills each team member brings to the team and which team members are best suited for particular roles on the team. The team success template module 3404 is then executed to access a list of critical skills required for the team. The current skills of the team members are then compared to the critical skills required for the team to identify gaps. Using this information, the team leader can work to fill the skill gap by adding/removing team members and/or by creating a development plan for one or more team members to develop the critical skills required by the team.

Technical effects and benefits of the exemplary embodiments include the ability to provide an online, highly interactive, user-driven solution to integrate self-knowledge and career management. Exemplary embodiments as described herein are designed to maximize human potential and to change how knowledge workers manage their careers. The career management software tool takes the user through a journey of self-discovery providing an understanding of personality type, temperament, transferable skills, values, and interests. The results of the self-discovery process are mapped to a career path, including determining possible occupations from a job taxonomy database that appear to be a good fit for the personality type, temperament, skills, values and interests of the user. Further, the career management software permits each user to self-validate outcomes at each stage. These self-discovery outputs are highly actionable and the user can explore specific job profiles with detailed descriptions that are served-up from an extensive job taxonomy database. Additionally, users can build a “passion-based” resume, script a succinct statement of career objectives and prepare for in-person interviews, all with individualized content harvested from the self-discovery process.

As described above, the embodiments of the invention may be embodied in the form of hardware, software, firmware, or any processes and/or apparatuses for practicing the embodiments. Embodiments of the invention may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

1. A method for facilitating self-knowledge and career management, the method comprising:
providing a user interface to a career management software tool including a type and temperament module, a skills and experiences module, and a career interests module, the user interface having a screen flow and including illustrated scenarios as a form of stimuli;
executing one or more of the modules to determine characteristics of a user, the executing comprising receiving information from the user via the user interface and performing user validation of the determined characteristics including altering the screen flow in response to the information;
accessing a job taxonomy database that includes occupational themes and associated occupational characteristics to select a subset of the occupational themes based on the determined characteristics of the user; and
transmitting the subset of the occupational themes to the user via the user interface.

2. The method of claim 1 wherein the type and temperament module is executed to determine characteristics of the user relating to a type and temperament of the user including psychic energy, information gathering, deciding, and executing characteristics, wherein the user validation is performed by having the user confirm that the type and temperament characteristics are descriptive of the user and the user validation includes using tie breaker screens when the user indicates that additional data is required to perform the user validation.

3. The method of claim 1 wherein the skills and experiences module is executed to determine characteristics of the user relating to skills of the user including physical skills, social skills, information skills, and ideas skills characteristics, and the information from the user includes text entry of life experiences of the user which are mapped to the skills characteristics.

4. The method of claim 1 wherein the career management software tool further includes a sector sort module to determine characteristics of the user relating to preferred career sectors of the user.

5. The method of claim 1 wherein the career interests module is executed to determine characteristic of the user relating to career interests of the user, and the information includes preferred occupational themes selected by the user.

6. The method of claim 1 wherein the career management software tool further includes a values toggle module to determine characteristics of the user relating to values of the user and to rank the occupational themes based on a comparison of the values of the user to values associated with the occupational themes.

7. The method of claim 1 wherein the determined characteristics are utilized to create an action plan including one or more of a resume, an elevator pitch, and prepared answers to likely interview questions.

8. The method of claim 1 wherein the job taxonomy database further includes job titles associated with one or more of the occupational themes and the transmitting includes transmitting the job titles associated with one or more of the occupational themes in the subset of the occupational themes.

9. The method of claim 1 wherein the user is one or more of a job applicant and a current employee of a corporation and the job taxonomy database includes occupational themes for job positions in the corporation.

10. The method of claim 1 wherein the career management software tool further includes a coaching module to facilitate online or offline coaching of the user.

11. The method of claim 1 further comprising transmitting occupational characteristics associated with one or more of the occupational themes to the user via the user interface.

12. A method for facilitating self-knowledge and career management, the method comprising:
providing a user interface to a career management software tool including a type and temperament module, a skills and experiences module, and a career interests module, the user interface having a screen flow and the modules including illustrated scenarios as a form of stimuli and the modules when executing receive information from the user via the user interface and perform user validation including altering the screen flow in response to the information;
executing the type and temperament module to determine type and temperament characteristics of the user;
selecting a first set of records from a job taxonomy database that includes occupational themes and associated occupational characteristics and job titles, the selecting based on the type and temperament characteristics of the user;
executing the skills and experiences module to determine skill characteristics of the user;
selecting a second set of records from the first set of records based on the skill characteristics of the user;
executing the career interests module to determine career interests characteristics of the user;
selecting a third set of records from the second set of records based on the career interest characteristics of the user; and
transmitting the occupational themes and the associated job titles in the third set of records to the user via the user interface.

13. A method for facilitating self-knowledge and career self-development, the method comprising:
executing a type and temperament module that utilizes a screen flow and illustrated scenarios to determine type and temperament characteristics of a user, the executing including communicating the determined characteristics to the user and user validation of the determined characteristics including altering the screen flow in response to the information;
executing a skills and experiences module to determine current skills of the user, the skills including one or more of physical skills, social skills, information skills, and ideas skills;
accessing a list of critical skills required for a job position;
comparing the current skills of the user to the critical skills; and
creating a development plan for the user in response to the comparing.

14. The method of claim 13 wherein the development plan includes suggested action items and more than half of the suggested action items are identified as actions that are user initiated and user controlled.

15. The method of claim 13 wherein the job position is a job currently held by the user.

16. The method of claim 13 wherein the job position is not a job currently held by the user.

17. The method of claim 13 wherein the list of critical skills for the job position are located in a job taxonomy database.

18. A computer program product for facilitating self-knowledge and career management, the computer program product comprising:
a storage medium readable by a processing circuit and storing instructions for execution by the processing circuit for performing a method comprising:
providing a user interface to a career management software tool including a type and temperament module, a skills and experiences module, and a career interests module, the user interface having a screen flow and including illustrated scenarios as a form of stimuli;
executing one or more of the modules to determine characteristics of a user, the executing comprising receiving information from the user via the user interface and performing user validation of the determined characteristics including altering the screen flow in response to the information;
accessing a job taxonomy database that includes occupational themes and associated occupational characteristics to select a subset of the occupational themes based on the determined characteristics of the user; and
transmitting the subset of the occupational themes to the user via the user interface.

19. A system for facilitating self-knowledge and career management, the system comprising:
a job taxonomy database including occupational themes and associated occupational characteristics;
a processor in communication with the job taxonomy database and with a user system, the processor including instructions to facilitate a method comprising:
providing a user interface to a career management software tool to a user via the user system, the tool including a type and temperament module, a skills and experiences module, and a career interests module, the user interface having a screen flow and including illustrated scenarios as a form of stimuli;
executing one or more of the modules to determine characteristics of the user, the executing comprising receiving information from the user via the user interface and performing user validation of the determined characteristics including altering the screen flow in response to the information;
accessing the job taxonomy database to select a subset of the job titles based on the determined characteristics of the user; and
transmitting the subset of the occupational themes to the user via the user interface.

20. A method for determining critical skills for a job position, the method comprising:
for one or more users having a selected job position:
executing a skills and experiences module to determine current skills of the user, each current skill categorized as one or more of a physical skill, a social skill, an information skill, and an ideas skill and the executing including facilitating an evaluation by the user of the importance of each of the current skills to the job position; and
creating a list of critical skills for the selected job position based on the current skills and the evaluations of the users.

21. The method of claim 20 wherein the one or more users are top performers in the selected job position.

22. The method of claim 20 wherein the one or more users are supervisors of employees in the selected job position.

23. The method of claim 20 further comprising executing a type and temperament module that utilizes illustrated scenarios to determine type and temperament characteristics of the user, the executing including communicating the determined characteristics to the user and user validation of the determined characteristics including altering the screen flow in response to the information.

24. The method of claim 23 further comprising creating a list of type and temperament characteristics associated with the selected job position based on the determined type and temperament characteristics of the users.

25. The method of claim 20 further comprising:
executing the skills and experiences module to determine current skills of a current employee;
accessing the list of critical skills required for the selected job position;
comparing the current skills of the current employee to the critical skills; and
creating a development plan for the current employee user in response to the comparing.

26. The method of claim 20 further comprising:
executing the skills and experiences module to determine current skills of a prospective employee for the selected job position;
accessing the list of critical skills required for the selected job position;
comparing the current skills of the prospective employee to the critical skills; and
determining a fit between the prospective employee and the selected job position in response to the comparing.

27. A method for determining critical skills for a team, the method comprising:
for one or more users associated with a team:
executing a type and temperament module that utilizes illustrated scenarios to determine type and temperament characteristics of the user, the executing including communicating the determined characteristics to the user and user validation of the determined characteristics including altering the screen flow in response to information received from the user; and
executing a skills and experiences module to determine current skills of the user, each current skill categorized as one or more of a physical skill, a social skill, an information skill, and an ideas skill; and
accessing a list of critical skills required for the team;
comparing the current skills of the users to the critical skills required for the team to identify gaps between the current skills of the user and the critical skills required for the team.

28. The method of claim 26 further comprising creating a development plan for one or more the users associated with the team to fill one or more of the identified gaps.
